(19) United States
(12) Patent Application Publication
(10) Pub. No.: US 2024/0057667 A1
(43) Pub. Date: Feb. 22, 2024

(54) AN ASSEMBLY FOR AN AEROSOL PROVISION DEVICE

(71) Applicant: NICOVENTURES TRADING LIMITED, London (GB)

(72) Inventors: Thomas Paul BLANDINO, Madison, WI (US); Keith George BEIDELMAN, Madison, WI (US); Anthony KLEIN, Salem, MA (US); Kevin MOONEY, Salem, MA (US); Johan SOMMARSTROM, London (GB); Guy Arthur DURHAM, London (GB)

(21) Appl. No.: 18/260,209

(22) PCT Filed: Jan. 7, 2022
(86) PCT No.: PCT/EP2022/050284

§ 371 Date: Jun. 30, 2023

Related U.S. Application Data
(60) Provisional application No. 63/199,565, filed on Jan. 8, 2021.

(51) Int. Cl. A24F 40/46; A24F 40/51; H05B 3/18; H05B 1/02

(52) U.S. Cl. CPC A24F 40/46; A24F 40/51; H05B 3/18; H05B 1/0244

(57) ABSTRACT

Disclosed herein is an assembly for an aerosol provision device for heating aerosol-generating material to volatilize at least one component of the aerosol-generating material. The assembly can include a heating zone for receiving aerosol-generating material to be heated, a structure, and at least one continuous electrically conductive path supported by the structure and configured to perform a first function of detecting temperature of the heating zone on the basis of an electrical resistance of the at least one path and/or a second function of heating the heating zone by resistance heating. The at least one path extends along at least two distinct portions of the structure. The at least one path can include a multiplicity of turns within each of the at least two distinct portions of the structure. The at least two distinct portions of the structure are offset from each other by a gap which is substantially free of the at least one path.

### PRIORITY CLAIM

The present application is a National Phase entry of PCT Application No. PCT/EP2022/050284, filed Jan. 7, 2022, which claims priority from U.S. Application No. 63/199,565, filed Jan. 8, 2021, each of which is hereby fully incorporated herein by reference.

### TECHNICAL FIELD

The present disclosure relates to an assembly for an aerosol provision device, an aerosol provision device, and an aerosol provision system comprising an aerosol provision device. The aerosol provision device is for generating an inhalable medium by heating aerosol-generating material to volatilize at least one component of the aerosol-generating material.

### BACKGROUND

Smoking articles, such as cigarettes, cigars and the like, burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

A first aspect of the present disclosure provides an assembly for an aerosol provision device for heating aerosol-generating material to volatilize at least one component of the aerosol-generating material, the assembly comprising: a heating zone for receiving aerosol-generating material to be heated; a structure; and at least one continuous electrically conductive path supported by the structure and configured to perform a first function of detecting temperature of the heating zone on the basis of an electrical resistance of the at least one path and/or a second function of heating the heating zone by resistance heating; wherein the at least one path extends along at least two distinct portions of the structure; wherein the at least one path comprises a multiplicity of turns within each of the at least two distinct portions of the structure; and wherein the at least two distinct portions of the structure are offset from each other by a gap which is substantially free of the at least one path.

In some embodiments, the gap extends in an extension direction, wherein the extension direction corresponds to a direction away from a longitudinal direction of the heating zone. In some embodiments, the extension direction is perpendicular to the longitudinal direction of the heating zone.

In some embodiments, the gap follows a pathway that is arcuate. In some embodiments, the pathway is a circumferential pathway that extends at least part way round the heating zone.

In some embodiments, the gap extends along a first plane and a longitudinal axis of the heating zone extends along a second plane, wherein the first plane is orthogonal to the second plane.

In some embodiments, the at least one path comprises a single portion in the gap. In some embodiments, the single portion is a connection portion that extends across the gap to connect the at least two distinct portions of the structure. In some embodiments, the single portion extends across a width direction of the gap.

In some embodiments, a portion of the at least one path in the gap occupies less than 10% of an area of the gap. In some embodiments, the portion occupies less than 5% of an area of the gap.

In some embodiments, the at least two portions of the structure are distinct due to a size of the gap relative to a size of a spacing between adjacent portions of the at least one path within each of the two portions of the structure.

In some embodiments, a dimension of the gap in a first direction is greater than a distance from one turn of the multiplicity of turns to an adjacent one turn of the multiplicity of turns in the first direction. In some embodiments, a dimension of the gap in a second direction is less than the distance from one turn of the multiplicity of turns to the adjacent one turn of the multiplicity of turns. In some embodiments, the first direction is orthogonal to the second direction.

In some embodiments, each portion comprises at least one repeating pattern.

In some embodiments, the at least one path occupies at least 40% of an area of the structure in at least one of the two distinct portions. In some embodiments, the at least one path occupies between 40% and 60% of an area of the structure in at least one of the two distinct portions.

In some embodiments, the at least one path surrounds heating zone. In some embodiments, the at least one path forms a single layer. In some embodiments, the single layer comprises a circular cross-section.

In some embodiments, adjacent edges of the at least one path are closer to each other within each of the at least two distinct portions of the structure compared to adjacent edges of the at least one path between the at least two distinct portions of the structure.

In some embodiments, the at least one path comprises a multiplicity of straights within each of the at least two distinct portions of the structure, wherein each straight is interconnected by two turns of the multiplicity of turns. In some embodiments, a majority of the straights are parallel to each other. In some embodiments, adjacent straights of the multiplicity of straights are spaced apart from each other by a spacing that is smaller in size than the gap. In some embodiments, a size of the gap is smaller than double a width of each straight. In some embodiments, a width of the gap is smaller than double the width of each straight. In some embodiments, the width of the gap is between 50% and 200% of the width of each straight. In some embodiments, the width of the gap is between 50% and 150% of the width of each straight. In some embodiments, any one straight of the multiplicity of straights extends only part way around the heating zone. In some embodiments, any one straight of the multiplicity of straights extends only part way along the heating zone. In some embodiments, a maximum length of any one straight of the multiplicity of straights of the at least one path is longer than a maximum length of any one straight of the multiplicity of straights.

In some embodiments, each distinct portion comprises a boundary of each of the at least two portions is rectilinear. In some embodiments, the boundary comprises a shape corresponding to a polygon. In some embodiments, the polygon is a quadrilateral. In some embodiments, the quadrilateral is a square or a rectangle. In some embodiments, a direction of each of the boundary lines is tangential to one turn of the multiplicity of turns. In some embodiments, the direction of each of the boundary lines is parallel or perpendicular to each one straight of the multiplicity of straights. In some embodiments, the direction of each of the boundary lines is either tangential to any one turn of the multiplicity of turns or parallel to any one straight of the multiplicity of straights.

In some embodiments, a first spacing between adjacent portions of the at least one path is greater in a region of the gap than a second spacing between adjacent portions of the at least one path outside the region of the gap.

In some embodiments, the gap extends to at least one turn of the multiplicity of turns within each of the at least two distinct portions of the structure. In some embodiments, the gap extends to a plurality of turns of the multiplicity of turns within each of the at least two distinct portions of the structure.

In some embodiments, the at least two distinct portions of the structure are arranged with respect to each other in a longitudinal direction of the heating zone. In some embodiments, each of the distinct portions of the structure is arranged with respect to each other one of the distinct portions in a longitudinal direction of the heating zone or a direction perpendicular to the longitudinal direction.

In some embodiments, each one turn of the multiplicity of turns is arcuate. That is, each one of the turns is not square in order to reduce mechanical stress on the one turn. In some embodiments, each one turn of the multiplicity of turns is round. In some embodiments, each one turn of the multiplicity of turns is circular.

In some embodiments, a radius of each one turn of the multiplicity of turns is greater than a thickness of the at least one path. In some embodiments, the radius of each one turn of the multiplicity of turns is at least 110% of the thickness of the at least one path. In some embodiments, the radius of each one turn of the multiplicity of turns is at least 125% of the thickness of the at least one path. In some embodiments, the radius of each one turn of the multiplicity of turns is between 110% and 190% of the thickness of the at least one path. In some embodiments, the radius of each one turn of the multiplicity of turns is between 125% and 175% of the thickness of the at least one path.

In some embodiments, a first width of the at least one path within at least one turn of the multiplicity of turns is greater than a second width of the at least one path outside of the at least one turn of the multiplicity of turns. In some embodiments, the second width is a width of one of the straights. In some embodiments, first width is at least 25% greater than the second width. In some embodiments, the first width is a width of a turn greater than 90 degrees and is at least 50% greater than the second width. In some embodiments, a width of the at least one path within at least one turn of the multiplicity of turns varies within the turn. In some embodiments, a width of the at least one path within at least one turn of the multiplicity of turns increases towards a mid-point of the turn.

In some embodiments, a width of the at least one path within a 180-degree turn is greater than a width of the at least one path within a 90-degree turn. In some embodiments, the width of the at least one path within a 90-degree turn is between 75% and 95% of the width of the at least one path within a 180-degree turn. In some embodiments, the width of the at least one path within a 90-degree turn is between 80% and 90% of the width of the at least one path within a 180-degree turn.

In some embodiments, the at least one path comprises a stress-relief feature comprising: a first turn in a first direction followed by a second turn in a second direction; wherein a length of the at least one path between the first and second turns is less than a length of one of the first and second turns. In some embodiments, the length of the at least one path between the first and second turns is less than the length of both the first and second turns. In some embodiments, the stress-relief feature comprises a third turn in the first direction. In some embodiments, a length of the at least one path between the second and third turns is less than a length of one of the first, second and third turns. In some embodiments, a length of the at least one path between the second and third turns is less than the length of both the first, second and third turns. In some embodiments, the length of the at least one path between the first and second turns is the same as the length of the at least one path between the second and third turns. In some embodiments, the length of the at least one path between one of the first and second turns and the second and third turns is negligible compared to the length of the one of the first, second and third turns. In some embodiments, at least one of the first to third turns is a 180-degree turn. In some embodiments, the second turn is a 180-degree turn. In some embodiments, two of the first to third turns are 90-degree turns. In some embodiments, at least one of the first to third turns is a 180-degree turn.

In some embodiments, the at least one path comprises a connection portion that extends across the gap to connect the at least two distinct portions of the structure. In some embodiments, the connection portion extends across the gap at one end of the at least two distinct portions of the structure. In some embodiments, the connection portion comprises one turn of the multiplicity of turns. In some embodiments, the connection portion comprises an internal facing turn that faces towards a center of the gap. In some embodiments, the center of the gap is with respect to a length of the gap. In some embodiments, the connection portion comprises an external facing turn that faces away from the center of the gap. In some embodiments, the connection portion is additionally a stress-relief feature. In some embodiments, the connection portion may perform the first and/or second function to a lesser extent than other portions of the at least one path within each of the at least two distinct portions of the structure.

In some embodiments, the multiplicity of turns comprises a major turn and a minor turn, which differ in angle of rotation about a central axis of rotation, measured in degrees. In some embodiments, the major turn is at least 45 degrees more than the minor turn. In some embodiments, the major turn is at least 90 degrees more than the minor turn. In some embodiments, the major turn has an angle of rotation of between 45 degrees and 135 degrees more than an angle of rotation of the minor turn. In some embodiments, the multiplicity of turns comprises at least one 180-degree turn. In some embodiments, the multiplicity of turns comprises at least one 90-degree turn. In some embodiments, the majority of the multiplicity of turns are 180-degree turns.

In some embodiments, the multiplicity of turns comprises at least one semi-circle turn. In some embodiments, a majority of the multiplicity of turns comprises semi-circle turns. In some embodiments, the multiplicity of turns comprises at least one quarter-circle turn. In some embodiments, a majority of the multiplicity of turns comprises quarter-circle turns.

In some embodiments, the at least one path comprises a first portion and a second portion that extend to and cross different respective sides of one of the at least two distinct portions of the structure.

In some embodiments, a number of turns per unit length of the at least one path within one of the at least two distinct portions of the structure is different in one region of the at least two distinct portions of the structure compared to another region of the at least two distinct portions of the structure.

In some embodiments, the at least one path extends side-to-side from one end to another within each of the at least two distinct portions of the structure.

In some embodiments, the multiplicity of turns within each of the at least one path form respective arrays of rows within the at least two distinct portions of the structure and columns within the at least two the distinct portions. In some embodiments, the array comprises a multiplicity of straights. In some embodiments, the rows are predominantly formed by the multiplicity of straights joined by the multiplicity of turns. In some embodiments, the straights extend in a longitudinal direction of the heating zone.

In some embodiments, the heating zone comprises a cross-section having a shape corresponding to a regular polygon. In some embodiments, the shape of the cross-section is arcuate. In some embodiments, the shape of the cross-section corresponds to a circle.

In some embodiments, the structure is or comprises at least one electrically insulating element and the at least one continuous electrically conductive path is a continuous electrically conductive wire encapsulated by the at least one electrically insulating element. In some embodiments, the wire comprises a circular cross-section. In some embodiments, the wire comprises a circular cross-section along substantially an entire length of the wire.

In some embodiments, the assembly comprises a plurality of continuous electrically conductive paths, wherein each of a first path and a second path of the plurality of continuous electrically conductive paths extends along at least two distinct portions of the structure in a respective first region and a second region; and wherein the first and second regions are offset from each other by a gap which is free of any one of the plurality of paths. In some embodiments, the first and second regions are offset from each other in a longitudinal direction of the assembly. In some embodiments, the first and second regions are offset from each other in a longitudinal direction of the heating zone. In some embodiments, the longitudinal direction of the heating zone is parallel to the longitudinal direction of the assembly.

In some embodiments, the second path is substantially a mirror image of the first path about an imaginary line between the first path and second path. In some embodiments, a width of the first region is substantially equal to a width of the second region.

In some embodiments, the heating zone comprises a first heating zone and a second heating zone, wherein the first path in the first region is to perform the first and/or second function with respect to the first heating zone and the second path in the second region is to perform the first and/or second function with respect to the second heating zone. In some embodiments, the second path in the second region is to perform the same function as the first path in the first region.

In some embodiments, the plurality of paths is supported by a same side of the structure.

In some embodiments, the structure is or comprises at least one electrically insulating element and at least one of the plurality continuous electrically conductive paths is a continuous electrically conductive wire encapsulated by the at least one electrically insulating element. In some embodiments, the wire comprises a circular cross-section. In some embodiments, the wire comprises a circular cross-section along substantially an entire length of the wire.

In some embodiments, the structure is or comprises an electrically insulating substrate and the at least one continuous electrically conductive path is a continuous electrically conductive track formed on the electrically insulating substrate.

In some embodiments, the assembly comprises a plurality of structures provided as a plurality of structure layers, a plurality of continuous electrically conductive paths, wherein at least one of the plurality of continuous electrically conductive paths is supported by each one of the plurality of structure layers, wherein each of the plurality of paths is to perform a different one of the first and second functions.

In some embodiments, each of the at least one path extends along at least two distinct portions of each of the plurality of structures in a respective region, and each of the regions overlap each other.

In some embodiments, the assembly comprises a plurality of structures provided as a plurality of structure layers; a plurality of continuous electrically conductive paths supported by each one of the plurality of structure layers; wherein a first path and a second path of the plurality of continuous electrically conductive paths are each supported by a first structure layer, and a third path and a fourth path of the plurality of continuous electrically conductive paths are each supported by a second structure layer; wherein each of the first to fourth paths extends along at least two distinct portions of the respective structure in a respective first to fourth region; and wherein each of the first and second regions on the first structure layer overlaps at least one of the third and fourth regions on the second structure layer.

In some embodiments, each of the plurality of structure layers is to perform a different one of the first and second functions.

In some embodiments, any limitation defined in relation to one of the paths also applies to any one or any combination of the other paths. For example, in some embodiments, one path extends side-to-side from one end to another within each of the at least two distinct portions of the first structure.

In some embodiments, any limitation defined in relation to the at least two portions of one of the structures also applies to any one or any combination of the at least two portions of the other structures.

In some embodiments, a length of a first path is less than 0.5 m. In some embodiments, the length of the first path is between 0.2 m and 0.4 m. In some embodiments, the length of the first path is between 0.3 m and 0.35 m. In some embodiments, the length of the first path is 333.85 mm.

In some embodiments, a length of a second path is less than 0.5 m. In some embodiments, the length of the second path is between 0.2 m and 0.4 m. In some embodiments, the length of the second path is between 0.3 m and 0.35 m. In some embodiments, the length of the second path is 328.95 mm.

In some embodiments, a length of a second path is between 90% and 110% of the length of the first path. In some embodiments, a length of the second path is between 95% and 105% of the length of the first path. In some embodiments, the length of the second path differs from a length of the first path by less than or equal to 10 mm. In some embodiments, the length of the second path differs from a length of the first path by less than or equal to 5 mm. In some embodiments, a difference between the length of the second path and a length of the first path is less than or equal to 5%. In some embodiments, a difference between the length of the second path and a length of the first path is less than or equal to 3%.

In some embodiments, a thickness of the at least one path is less than 1 mm. In some embodiments, the thickness of the at least one path is less than 0.1 mm. In some embodiments, the thickness of the at least one path is between 40 μm and 60 μm. In some embodiments, the thickness of the at least one path is 50.8 μm (0.0508 mm).

In some embodiments, a thickness of a second path is between 90% and 110% of the thickness of a first path. In some embodiments, the thickness of the second path is between 95% and 105% of the thickness of the first path. In some embodiments, the thickness of the second path differs from the thickness of the first path by less than or equal to 10 μm. In some embodiments, the thickness of the second path differs from the thickness of the first path by less than or equal to 5 μm. In some embodiments, the thickness of the second path is the same as a thickness of the first path.

In some embodiments, a width of the at least one path is less than 1 mm. In some embodiments, the width of the at least one path is less than 0.6 mm. In some embodiments, the width of the at least one path is between 0.2 mm and 0.6 mm. In some embodiments, the width of the at least one path is between 0.3 mm and 0.4 mm. In some embodiments, the width of the at least one path is between 0.3175 mm.

In some embodiments, a majority width of the at least one path is less than 1 mm. In some embodiments, the majority width of the at least one path is less than 0.5 mm. In some embodiments, the majority width of the at least one path is between 0.2 mm and 0.4 mm. In some embodiments, the majority width refers to an average width of the entire path. In other embodiments, the majority width to an average width of the multiplicity of the straights of the at least one path.

In some embodiments, a majority width of a second path is between 90% and 110% of a majority width of a first path. In some embodiments, the majority width refers to an average width of the entire path. In other embodiments, the majority width refers to an average width of the multiplicity of the straights of the path. In some embodiments, a majority width of the second path is between 95% and 105% of the majority width of the first path. In some embodiments, the majority width of the second path is the same as a majority width of the first path.

In some embodiments, any one or all of a plurality of structures is/are provided externally of the heating zone.

In some embodiments, any one of the at least one path is made of a metallic material such as copper.

In some embodiments, at least one of the plurality of structures is or comprises an electrically insulating substrate and at least one of the plurality of paths is a continuous electrically conductive track formed on the electrically insulating substrate.

In some embodiments, at least one of the plurality of structures is or comprises at least one electrically insulating element and at least one of the plurality of continuous electrically conductive paths is a continuous electrically conductive wire encapsulated by the at least one electrically insulating element. That is, the at least one of the plurality of structures is or comprises the electrically insulating element. In some embodiments, the wire comprises a circular cross-section. In some embodiments, the wire comprises a circular cross-section along substantially an entire length of the wire.

In some embodiments, the at least one continuous electrically conductive path comprises a first electrical resistance under a predetermined condition when configured to perform the first function that is lower than a second electrical resistance configured to perform the second function. In some embodiments, the predetermined condition comprises a temperature and/or a voltage across the at least one continuous electrically conductive path. In some embodiments, the second electrical resistance is at least double the first resistance. In some embodiments, the second electrical resistance is between two and five times the first resistance. In some embodiments, the second electrical resistance is between three and four times the first resistance.

In some embodiments, the term “multiplicity” refers to a plurality.

A second aspect of the present disclosure provides an aerosol provision device for heating aerosol-generating material to volatilize at least one component of the aerosol-generating material, the device comprising: an assembly according to the first aspect; a controller for controlling a supply of power from a power source to the at least one continuous electrically conductive path of the assembly; and a detector for detecting an electrical resistance of the at least one path.

In some embodiments, the electrical resistance is detectable periodically by the detector.

In some embodiments, the controller is to convert the electrical resistance of the at least one path to temperature measurements of the at least one path. In some embodiments, at least one first connecting path connects the at least one path to the controller, wherein the at least one first connecting path is less susceptible to temperature changes of the heating zone than the at least one path. In some embodiments, the susceptibility of the at least one first connecting path to temperature is governed by a position of the at least one first connecting path with respect to the heating zone. In some embodiments, a length of the at least one first connecting path is positioned away from the heating zone in a longitudinal direction of the heating zone. In some embodiments, the temperature measurements account for a resistance of the first connecting path using predetermined information about the at least one path and the first connecting path. In some embodiments, the predetermined information comprises geometric information about the at least one path and the first connecting path. In some embodiments, the geometric information comprises a length of the at least one path and a length of the first connecting path. In some embodiments, the geometric information comprises a thickness and/or width of the at least one path and a thickness and/or width of the first connecting path. In some embodiments, at least one second connecting path connects the second path to the controller, wherein the at least one second connecting path is less susceptible to temperature changes of the heating zone than the second path. In some embodiments, the temperature measurements associated with the at least one path account for a resistance of a second path and/or the at least one second connecting path.

A third aspect of the present disclosure provides an aerosol provision system comprising an aerosol provision device according to the second aspect and a consumable comprising aerosol-generating material insertable into the heating zone of the assembly of the device.

A fourth aspect of the present disclosure provides a method of detecting temperature of a heating zone for receiving aerosol-generating material to be heated, comprising: controlling, by a controller a supply of power from a power source to at least one electrically conductive path; detecting, by a detector an electrical resistance of the at least one electrically conductive path; detecting, by the detector an electrical resistance of a portion of the at least one electrically conductive path away from the heating zone, on the basis of predetermined information about the portion; calculating a temperature of the heating zone, on the basis of the electrical resistance of the at least one electrically conductive path and an electrical resistance of the portion of the track away from the heating zone.

In some embodiments, the method comprises sampling the electrical resistance of the path for a predetermined duration. In some embodiments, the predetermined duration is approximately 250 μs. In some embodiments, the predetermined duration is between 0.1 ms and 0.4 ms.

In some embodiments, the heating zone as described above in relation to the fourth aspect is comprised by an assembly as described above in relation to the first aspect.

In some embodiments, the at least one electrically conductive path as described above in relation to the fourth aspect comprises any feature or features of the electrically conductive path as described above in relation to the first aspect.

### BRIEF DESCRIPTION OF THE DRAWINGS

Embodiments of the disclosure will now be described, by way of example only, with reference to the accompanying drawings, in which:

FIG. 1 shows a schematic perspective view of an aerosol provision system comprising an aerosol provision device according to an embodiment of the disclosure with a consumable comprising aerosol-generating material inserted, wherein the device is for heating the aerosol-generating material of the consumable to volatilize at least one component of the aerosol-generating material.

FIG. 2 shows a schematic front cross-sectional view of the aerosol provision device of the aerosol provision system of FIG. 1 according to an embodiment of the disclosure without a consumable inserted.

FIG. 3 shows a schematic first view of an assembly for the device of FIG. 2 according to an embodiment of the disclosure.

FIG. 4 shows a schematic second view of the assembly shown in FIG. 3 for the device of FIG. 2 according to an embodiment of the disclosure.

FIG. 4A shows a schematic cross-sectional view of an alternative assembly for the device of FIG. 2 according to another embodiment of the disclosure.

FIG. 5 shows a schematic view of an electrical arrangement comprising electrically conductive tracks for the device of FIG. 2 according to an embodiment of the disclosure

FIG. 6 shows a schematic enlarged view of one of the electrically conductive tracks shown in FIG. 5 according to an embodiment of the disclosure.

FIG. 7 shows a schematic enlarged view of an area of the track shown in FIG. 6 according to an embodiment of the disclosure.

FIG. 8 shows a schematic enlarged view of another area of the track shown in FIG. 6 according to an embodiment of the disclosure.

FIG. 9 shows a schematic enlarged view of a further area of the track shown in FIG. 6 according to an embodiment of the disclosure.

FIG. 10 shows a schematic enlarged view of a first distinct portion of the track shown in FIG. 6 according to an embodiment of the disclosure.

FIG. 11 shows a schematic enlarged view of an area of the track shown in FIG. 10 comprising a 180 degree turn according to an embodiment of the disclosure.

FIG. 12 shows a schematic enlarged view of a second distinct portion of the track shown in FIG. 6 according to an embodiment of the disclosure.

FIG. 13 shows a schematic enlarged view of a third distinct portion of the track shown in FIG. 6 according to an embodiment of the disclosure.

FIG. 14 shows a schematic enlarged view of an area of the track shown in FIG. 12 comprising a 90 degree turn according to an embodiment of the disclosure.

FIG. 15 shows a schematic view of another electrical arrangement comprising electrically conductive tracks for the device of FIG. 2 for overlaying onto the electrical arrangement of FIG. 5 according to an embodiment of the disclosure.

FIG. 16 shows a schematic cross-section of an assembly comprising substrate layers according to an embodiment of the disclosure, each substrate comprising electrically conductive tracks for the device of FIG. 2.

FIG. 17 shows a schematic view of the other electrical arrangement shown in FIG. 15 comprising electrically conductive tracks for the device of FIG. 2 according to an embodiment of the disclosure.

FIG. 18 shows a schematic enlarged view of one of the electrically conductive tracks shown in FIG. 17 according to an embodiment of the disclosure.

FIG. 19 shows a diagram of an electrical circuit for measuring a resistance of a first track.

### DETAILED DESCRIPTION OF THE DRAWINGS

The present disclosure relates to aerosol provision devices, such as non-combustible aerosol provision devices. According to the present disclosure, a “non-combustible” aerosol provision device is one where a constituent aerosol-generating material comprised by a consumable for receipt by a chamber of the aerosol provision device (or component thereof) is not combusted or burned in order to facilitate delivery of the aerosol-generating material to a user.

As used herein, the term “aerosol-generating material” includes materials that provide volatilized components upon heating, typically in the form of vapor or an aerosol. Aerosol-generating material may be a non-tobacco-containing material or a tobacco-containing material. Aerosol-generating material may, for example, include one or more of tobacco per se, tobacco derivatives, expanded tobacco, reconstituted tobacco, tobacco extract, homogenized tobacco or tobacco substitutes. The aerosol-generating material can be in the form of ground tobacco, cut rag tobacco, extruded tobacco, reconstituted tobacco, reconstituted aerosol-generating material, liquid, gel, amorphous solid, gelled sheet, powder, or agglomerates, or the like. Aerosol-generating material also may include other, non-tobacco, products, which, depending on the product, may or may not contain nicotine. Aerosol-generating material may comprise one or more humectants, such as glycerol or propylene glycol. The term “aerosol generating material” may also be used herein interchangeably with the term “aerosol-generating material”.

As used herein, the term “tobacco material” refers to any material comprising tobacco or derivatives therefrom. The term “tobacco material” may include one or more of tobacco, tobacco derivatives, expanded tobacco, reconstituted tobacco or tobacco substitutes. The tobacco material may comprise one or more of ground tobacco, tobacco fiber, cut tobacco, extruded tobacco, tobacco stem, reconstituted tobacco and/or tobacco extract.

The tobacco used to produce tobacco material may be any suitable tobacco, such as single grades or blends, cut rag or whole leaf, including Virginia and/or Burley and/or Oriental. It may also be tobacco particle ‘fines’ or dust, expanded tobacco, stems, expanded stems, and other processed stem materials, such as cut rolled stems. The tobacco material may be a ground tobacco or a reconstituted tobacco material. The reconstituted tobacco material may comprise tobacco fibers, and may be formed by casting, a Fourdrinier-based paper making-type approach with back addition of tobacco extract, or by extrusion.

As noted above, the aerosol-generating material may comprise an “amorphous solid”, which may alternatively be referred to as a “monolithic solid” (i.e. non-fibrous), or as a “dried gel”. The amorphous solid is a solid material that may retain some fluid, such as liquid, within it. In some cases, the aerosol-generating material comprises from about 50 wt %, 60 wt % or 70 wt % of amorphous solid, to about 90 wt %, 95 wt % or 100 wt % of amorphous solid. In some cases, the aerosol-generating material consists of amorphous solid.

As used herein, the term “sheet” denotes an element having a width and length substantially greater than a thickness thereof. The sheet may be a strip, for example.

As used herein, the term “heating material” or “heater material”, in some examples, refers to material that is heatable by penetration with a varying magnetic field, for example when the aerosol-generating material is heated by an inductive heating arrangement.

Other forms of heating a heating material include resistive heating which involves electrically resistive heating elements that heat up when an electric current is applied to the electrically resistive heating element, thus transferring heat by conduction to the heating material.

A susceptor is a material that is heatable by penetration with the varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

It has been found that, when the susceptor is in the form of a closed electrical circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example, as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule and magnetic hysteresis heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object.

Moreover, as induction heating and magnetic hysteresis heating do not require a physical connection to be provided between the source of the varying magnetic field and the object, design freedom and control over the heating profile may be greater, and cost may be lower.

In some embodiments, the aerosol provision device is an electronic cigarette, also known as a vaping device or electronic nicotine delivery system (ENDS), although it is noted that the presence of nicotine in the aerosol-generating material is not a requirement.

In some embodiments, the aerosol provision device is a tobacco heating device, also known as a heat-not-burn device.

In some embodiments, the aerosol provision device is a hybrid device to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid device comprises a liquid or gel aerosol-generating material and a solid aerosol-generating material. The solid aerosol-generating material may comprise, for example, tobacco or a non-tobacco product.

In some embodiments, the aerosol provision device may comprise a power source. The power source may, for example, be an electric power source.

In some embodiments, the consumable for use with the aerosol provision device may comprise an aerosol generating component, an aerosol generating area, a mouthpiece, and/or an area for receiving aerosol-generating material.

In some embodiments, the aerosol provision device may comprise an aerosol generating component. The aerosol generating component is a heater capable of interacting with the aerosol-generating material so as to release one or more volatiles from the aerosol-generating material to form an aerosol. In some embodiments, the aerosol generating component is capable of generating an aerosol from the aerosol-generating material without heating. For example, the aerosol generating component may be capable of generating an aerosol from the aerosol-generating material without applying heat thereto, for example via one or more of vibrational, mechanical, pressurization or electrostatic means. In some embodiments, the aerosol generating component may form part of the aerosol provision device.

In some embodiments, a substance to be delivered by the aerosol provision device may be an aerosol-generating material which may comprise an active constituent, a carrier constituent and optionally one or more other functional constituents.

The active constituent may comprise one or more physiologically and/or olfactory active constituents which are included in the aerosol-generating material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, theine, a vitamin such as B6 or B12 or C, melatonin, or a constituent, derivative, or combinations thereof. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, or mixtures thereof.

In some embodiments, the active constituent is an olfactory active constituent and may be selected from a “flavor” and/or “flavorant” which, where local regulations permit, may be used to create a desired taste, aroma or other somatosensorial sensation in a product for adult consumers. In some instances such constituents may be referred to as flavors, flavorant, cooling agents, heating agents, or sweetening agents. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis. In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, coloring agents, preservatives, binders, fillers, stabilizers, and/or antioxidants.

In some embodiments, the consumable for use with the aerosol provision device may comprise aerosol-generating material or an area for receiving aerosol-generating material. In some embodiments, the consumable for use with the aerosol provision device may comprise a mouthpiece. The area for receiving aerosol-generating material may be a storage area for storing aerosol-generating material. For example, the storage area may be a reservoir. In some embodiments, the area for receiving aerosol-generating material may be separate from, or combined with, an aerosol generating area.

Apparatus is known that heats aerosol-generating material to volatilize at least one component of the aerosol-generating material, typically to form an aerosol which can be inhaled, without burning or combusting the aerosol-generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol-generating material in the form of a liquid, which may or may not contain nicotine. The aerosol-generating material may be in the form of or be provided as part of a rod, cartridge or cassette or the like which can be inserted into the apparatus. An aerosol generator, such as a heater, for heating and volatilizing the aerosol-generating material may be provided as a “permanent” part of the apparatus.

Such an apparatus can receive a consumable comprising aerosol-generating material for heating. A “consumable” in this context is an article comprising or consisting of aerosol-generating material, part or all of which is intended to be consumed during use by a user. In some embodiments, the consumable is heated to volatilize the aerosol-generating material, and optionally other components in use. In other embodiments, heating may not be used to volatilize the aerosol-generating material, for example vibration may be used to generate aerosol. A user may insert the consumable into the aerosol generating device before it is heated to produce an aerosol, which the user subsequently inhales. The consumable may be, for example, of a predetermined or specific size that is configured to be placed within a chamber, such as a heating chamber, of the device which is sized to receive the consumable.

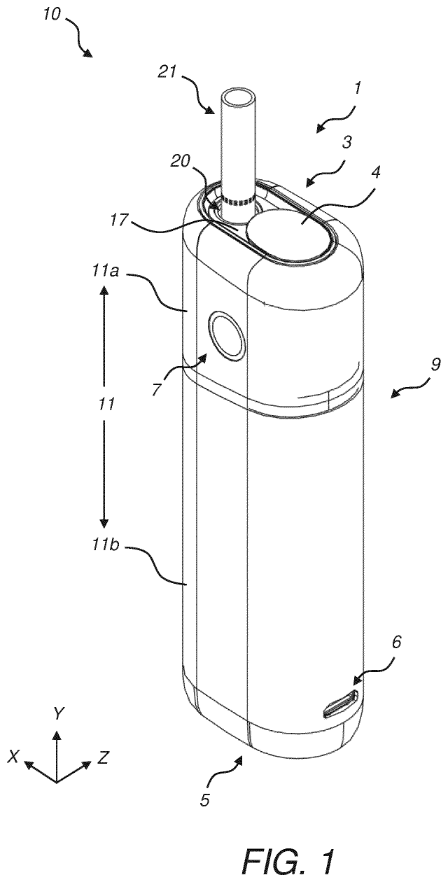

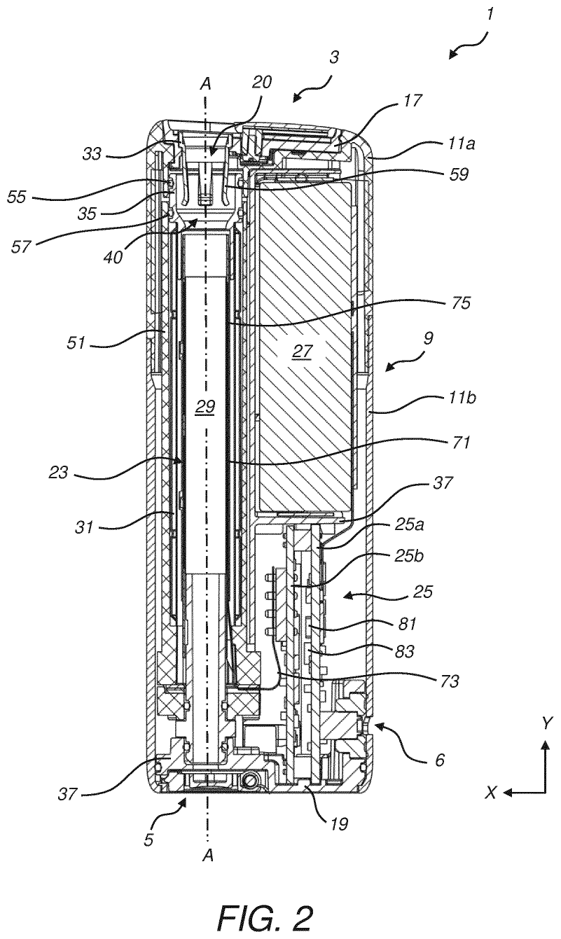

Referring to FIG. 1, there is shown a schematic perspective view of an aerosol provision system 10 comprising an aerosol provision device 1 (see FIG. 2) according to an embodiment of the disclosure with a consumable 21 inserted into the device 1. The aerosol provision device 1 is herein also referred to as an apparatus.

The apparatus 1 is for heating aerosol-generating material to volatilize at least one component of the aerosol-generating material to form an aerosol for inhalation by a user. In this embodiment, the aerosol-generating material comprises tobacco, and the apparatus 1 is a tobacco heating product (also known in the art as a tobacco heating device or a heat-not-burn device). The apparatus 1 is a handheld device for inhalation of the aerosol-generating material by the user of the handheld device.

The apparatus 1 comprises a first end 3 and a second end 5, opposite the first end 3. The first end 3 is sometimes referred to herein as the mouth end or proximal end of the apparatus 1. The second end 5 is sometimes referred to herein as the distal end of the apparatus 1. The apparatus 1 has an on/off button 7 to allow the apparatus 1, as a whole, to be switched on and off as desired by a user of the apparatus 1. In some embodiments, an activation mechanism other than an on/off button may be used to switch the apparatus on and/or off. An example activation mechanism includes voice activation.

In broad outline, the apparatus 1 is configured to generate an aerosol to be inhaled by a user by heating an aerosol generating material. In use, a user inserts the consumable 21 into the apparatus 1 and activates the apparatus 1, e.g. using the button 7, to cause the apparatus 1 to begin heating the aerosol generating material. The user subsequently draws on a mouthpiece 21b of the consumable 21 near the first end 3 of the apparatus 1 to inhale an aerosol generated by the apparatus 1. As a user draws on the consumable 21, generated aerosol flows through the apparatus 1 along a flow path towards the proximal end 3 of the apparatus 1.

In examples, a vapor is produced that then at least partly condenses to form an aerosol before exiting the apparatus 1 to be inhaled by the user.

In this respect, first it may be noted that, in general, a vapor is a substance in the gas phase at a temperature lower than its critical temperature, which means that, for example, the vapor can be condensed to a liquid by increasing its pressure without reducing the temperature. On the other hand, in general, an aerosol is a colloid of fine solid particles or liquid droplets, in air or another gas. A “colloid” is a substance in which microscopically dispersed insoluble particles are suspended throughout another substance.

For reasons of convenience, as used herein, the term aerosol should be taken as meaning an aerosol, a vapor or a combination of an aerosol and vapor.

The apparatus 1 comprises a casing 9 for locating and protecting various internal components of the apparatus 1. The casing 9 is therefore an external housing for housing the internal components. In the embodiment shown, the casing 9 comprises a sleeve 11 that encompasses a perimeter of the apparatus 1, capped with a top panel 17, at the first end 3, which defines generally the ‘top’ of the apparatus 1 and a bottom panel 19, at the second end 5 (see FIGS. 2 to 5), which defines generally the ‘bottom’ of the apparatus 1.

The sleeve 11 comprises a second sleeve 11a and a first sleeve 11b. The second sleeve 11a is provided at a top portion of the apparatus 1, shown as an upper portion of the apparatus 1, and extends away from the first end 3. The first sleeve 11b is provided at a bottom portion of the apparatus 1, shown as a lower portion of the apparatus 1, and extends away from the second end 5. The second sleeve 11a and first sleeve 11b each encompass a perimeter of the apparatus 1. That is, the apparatus 1 comprises a longitudinal axis in a Y-axis direction, and the second sleeve 11a and the first sleeve 11b each surround the internal components in a direction radial to the longitudinal axis.

The top panel 17 of the apparatus 1 has an opening 20 at the mouth end 3 of the apparatus 1 through which, in use, the consumable 21 containing aerosol-generating material is inserted into the apparatus 1 and removed from the apparatus 1 by a user. In this embodiment, an insertion direction and a removal direction are each parallel to a longitudinal axis A-A of a hollow interior heating chamber 29. In this embodiment, the longitudinal axis A-A is in a direction parallel to the longitudinal axis of the apparatus 1. In this embodiment, the consumable 21 acts as the mouthpiece for the user to place between lips of the user. In other embodiments, an external mouthpiece may be provided wherein at least one volatilized component of the aerosol-generating material is drawn through the mouthpiece. When an external mouthpiece is used, the aerosol-generating material is not provided in the external mouthpiece.

The opening 20 in this embodiment is opened and closed by a door 4. In the embodiment shown, the door 4 is movable between a closed position and an open position to allow for insertion of the consumable 21 into the apparatus 1 when in the open position. The door 4 is configured to move bi-directionally along an X-axis direction.

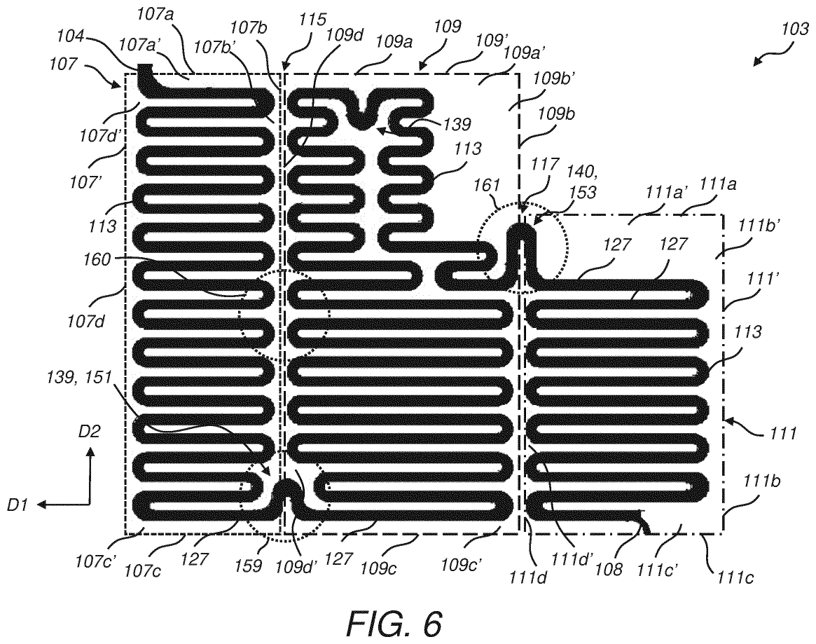

A connection port 6 is shown at the second end 5 of the apparatus 1. The connection port 6 is for connection to a cable and a power source 27 (shown in FIG. 6) for charging the power source 27 of the apparatus 1. The connection port 6 extends in a Z-axis direction from a front side of the apparatus 1 to a rear side of the apparatus 1. As shown in FIG. 1, the connection port 6 is accessible on a right-side of the apparatus 1 at the second end 5 of the apparatus 1. Advantageously, the apparatus 1 may stand on the second end 5 whilst charging or to provide a data connection through the connection port 6. In the embodiment shown, the connection port 6 is a USB socket.

FIG. 2 shows a schematic front cross-sectional view of the apparatus 1 as shown in FIG. 1 with the consumable 21 of FIG. 1 withdrawn.

The casing 9 has located or fixed therein a heater arrangement 23, control circuitry 25 and the power source 27. In this embodiment, the control circuitry 25 is part of an electronics compartment and comprises two printed circuit boards (PCBs) 25a, 25b. In this embodiment, the control circuitry 25 and the power source 27 are laterally adjacent to the heater arrangement 23 (that is, adjacent when viewed from an end), with the control circuitry 25 being located below the power source 27. Advantageously, this provides allows the apparatus 1 to be compact in a lateral direction, corresponding to the X-axis direction.

The control circuitry 25 in this embodiment includes a controller 81, such as a microprocessor arrangement, configured and arranged to control the heating of the aerosol-generating material in the consumable 21, as discussed further below. The control circuitry 25 further includes a detector 83 for detecting an electrical resistance of at least one continuous electrically conductive track, such as an electrically conductive path discussed below in the form of an electrically conductive track or an electrically conductive wire.

The power source 27 in this embodiment is a rechargeable battery. In other embodiments, a non-rechargeable battery, a capacitor, a battery-capacitor hybrid, or a connection to a mains electricity supply may be used. Examples of suitable batteries include for example a lithium-ion battery, a nickel battery (such as a nickel-cadmium battery), an alkaline battery and/or the like. The battery 27 is electrically coupled to the heater arrangement 23 to supply electrical power when required and under control of the control circuitry 25 to heat the aerosol-generating material in the consumable (as discussed, to volatilize the aerosol-generating material without causing the aerosol-generating material to burn).

An advantage of locating the power source 27 laterally adjacent to the heater arrangement 23 is that a physically large power source 27 may be used without causing the apparatus 1, as a whole, to be unduly lengthy. As will be understood, in general, a physically large power source 27 has a higher capacity (that is, the total electrical energy that can be supplied, often measured in Amp-hours or the like) and thus the battery life for the apparatus 1 can be longer.

In one embodiment, the heater arrangement 23 is generally in the form of a hollow cylindrical tube, comprising the hollow interior heating chamber 29 into which the consumable 21 comprising the aerosol-generating material is inserted for heating, in use. Broadly speaking, the heating chamber 29 is a heating zone for receiving the consumable 21. Different arrangements for the heater arrangement 23 are possible. In some embodiments, the heater arrangement 23 may comprise a single heating element or may be formed of plural heating elements aligned along the longitudinal axis of the heater arrangement 23. The or each heating element may be annular or tubular, or at least part-annular or part-tubular around its circumference. In an embodiment, the or each heating element may be a thin-film heater. In another embodiment, the or each heating element may be made of a ceramics material. Examples of suitable ceramics materials include alumina and aluminum nitride and silicon nitride ceramics, which may be laminated and sintered. Other heater arrangements are possible, including for example inductive heating, infrared heater elements, which heat by emitting infrared radiation, or resistive heating elements formed by for example a resistive electrical winding.

In this embodiment, the heater arrangement 23 is supported by a stainless steel support tube 75 and comprises a heater 71. In one embodiment, the heater 71 may comprise a substrate in which at least one electrically conductive element is formed. The substrate may be in the form of a sheet and may comprise for example a plastics layer. In one embodiment the layer is a polyimide layer. The electrically conductive element/s may be printed or otherwise deposited in the substrate layer. The electrically conductive element/s may be encapsulated within or coated with the substrate.

The support tube 75 is a heating element that transfers heat to the consumable 21. The support tube 75 comprises therefore heating material. In this embodiment, the heater material is stainless steel. In other embodiments, other metallic materials may be used as the heating material. For example, the heating material may comprise a metal or a metal alloy. The heating material may comprise one or more materials selected from the group consisting of: aluminum, gold, iron, nickel, cobalt, conductive carbon, graphite, steel, plain-carbon steel, mild steel, ferritic stainless steel, molybdenum, copper, and bronze.

The heater arrangement 23 is dimensioned so that substantially the whole of the aerosol-generating material when the consumable 21 is inserted in the apparatus 1 so that substantially the whole of the aerosol-generating material is heated in use.

In some embodiments, the or each heating element may be arranged so that selected zones of the aerosol-generating material can be independently heated, for example in turn (over time) or together (simultaneously) as desired.

The heater arrangement 23 in this embodiment is surrounded along at least part of its length by a vacuum region 31. The vacuum region 31 helps to reduce heat passing from the heater arrangement 23 to the exterior of the apparatus 1. This helps to keep down the power requirements for the heater arrangement 23 as it reduces heat losses generally. The vacuum region 31 also helps to keep the exterior of the apparatus 1 cool during operation of the heater arrangement 23. In some embodiments, the vacuum region 31 may be surrounded by a double-walled sleeve wherein the region between the two walls of the sleeve has been evacuated to provide a low-pressure region so as to minimize heat transfer by conduction and/or convection. In other embodiments, another insulating arrangement may be used, for example using heat insulating materials, including for example a suitable foam-type material, in addition to or instead of a vacuum region.

The casing 9, sometimes referred to as a housing, may further comprise various internal support structures 37 (best seen in FIG. 6) for supporting all internal components, as well as the heater arrangement 23.

The apparatus 1 further comprises a collar 33 which extends around and projects from the opening 20 into the interior of the housing 9 and an expansion element 35 which is located between the collar 33 and one end of the vacuum region 31. The expansion element 35 is a funnel that forms an expansion chamber 40 at the mouth end 3 of the apparatus 1. The collar 33 is a retainer for retaining the consumable 21. In this embodiment, the retainer is reversibly removable from the apparatus 1.

One end of the expansion element 35 connects to and is supported by the second sleeve 11a and the other end of the expansion element 35 connects to and is support by one end of a cassette 51. A first sealing element 55, shown as an o-ring, is interposed between the expansion element 35 and the second sleeve 11a, and a second sealing element 57, also shown as an o-ring, is interposed between the expansion element 35 and the cassette 51. Each o-ring is made of silicone, however, other elastomeric materials may be used to provide the seal. The first and second sealing elements 55, 57 prevent the transmission of gas into surrounding components of the apparatus 1. Sealing elements are also provided at the distal end to prevent fluid ingress and egress at the distal end.

As best seen in FIG. 2, the collar 33, the expansion element 35 and the vacuum region 31/heater arrangement 23 are arranged co-axially, so that, when the consumable 21 is inserted in the apparatus 1, the consumable 21 extends through the collar 33 and the expansion element 35 into the heating chamber 29.

As mentioned above, in this embodiment, the heater arrangement 23 is generally in the form of a hollow cylindrical tube. The heating chamber 29 formed by this tube is in fluid communication with the opening 20 at the mouth end 3 of the apparatus 1 via the expansion chamber 40.

In this embodiment, the expansion element 35 comprises a tubular body that has a first open end adjacent the opening 20 and a second open end adjacent the heating chamber 29. The tubular body comprises a first section that extends from the first open end to approximately half away along the tubular body and a second section that extends from approximately half away along the tubular body to the second open end. The first section comprises a flared portion that widens away from the second section. The first section therefore has an internal diameter that tapers outwardly towards the opening first open end. The second section has a substantially constant internal diameter.

As best seen in FIG. 2, in this embodiment, the expansion element 35 is located in the housing 9 between the collar 33 and the vacuum region 31/heater arrangement 23. More specifically, at the second open end, the expansion element 35 is interposed between an end portion of the support tube 75 of the heater arrangement 23 and an inside of the vacuum region 31 so that the second open end of the expansion element 35 engages with the support tube 75 and the inside of the vacuum region 31. At the first open end, the expansion element 35 receives the collar 33 so that legs 59 of the collar 33 project into the expansion chamber 40 to gently compress or pinch the consumable 21. Therefore, an inner diameter of the first section of the expansion element 35 is greater than an external diameter of the legs when the consumable 21 is received in the apparatus 1 and when no consumable 21 is present.

The top panel 17 generally forms the first end 3 of the housing 9 of the apparatus 1. The top panel 17 supports the collar 33 which defines an insertion point in the form of the opening 20 through which the consumable 21 is removably inserted into the apparatus 1 in use.

In this embodiment, the consumable 21 is in the form of a cylindrical rod which has or contains aerosol-generating material at a rear end in a section of the consumable 21 that is within the heater arrangement 23 when the consumable 21 is inserted in the apparatus 1. A front end of the consumable 21 extends from the apparatus 1 and acts as the mouthpiece which is an assembly that includes one or more of a filter for filtering aerosol and/or a cooling element for cooling aerosol. The filter/cooling element is spaced from the aerosol-generating material by a space. The consumable 21 is circumferentially wrapped in an outer layer (not shown). In this embodiment, the outer layer of the consumable 21 is permeable to allow some heated volatilized components from the aerosol-generating material to escape the consumable 21.

In operation, the heater arrangement 23 will heat the consumable 21 to volatilize at least one component of the aerosol-generating material.

As shown in FIG. 2, the support tube 75 is externally wrapped by a heater 71. In this example, the heater 71 is a thin-film heater comprising polyimide and electrically conductive elements. The heater 71 may comprise a plurality of heating regions that are independently controlled and/or simultaneously controlled. In this example, the heater 71 is formed as a single heater. However, in other embodiments, the heater 71 may be formed of a plurality of heaters aligned along the longitudinal axis of the heating chamber 29. In some embodiments, a plurality of temperature sensors may be used to detect the temperature of the heater 71 and/or support tube. The support tube 75 in this embodiment is made from stainless steel to conduct heat from the heater 71 towards the consumable 21 when the consumable 21 is inserted in a heating zone (the heating zone is defined by the thermal conduction region of the support tube 75). In other embodiments, the support tube 75 may be made from a different material, as long as the support tube 75 is thermally conductive. Other heating elements 75 may be used in other embodiments. For example, the heating element may be a susceptor that is heatable by induction. In this embodiment, the support tube 75 acts as an elongate support for supporting, in use, the 21 comprising aerosol-generating material.

In this embodiment, the heater 71 is located externally of the support tube 75. However, in other embodiments, the heater 71 may be located internally of the support tube 75. The heater 71 in this embodiment comprises a portion that passes outside of the support tube 75 and is referred to herein as a heater tail 73. The heater tail 73 extends beyond the heating chamber 29 and is configured for electrical connection to the control circuitry 25. In the embodiment shown, the heater tail 73 physically connects to one PCB 25a. An electrical current may be provided by the power source 27 to the heater 71 via the control circuitry 25 and the heater tail 73.

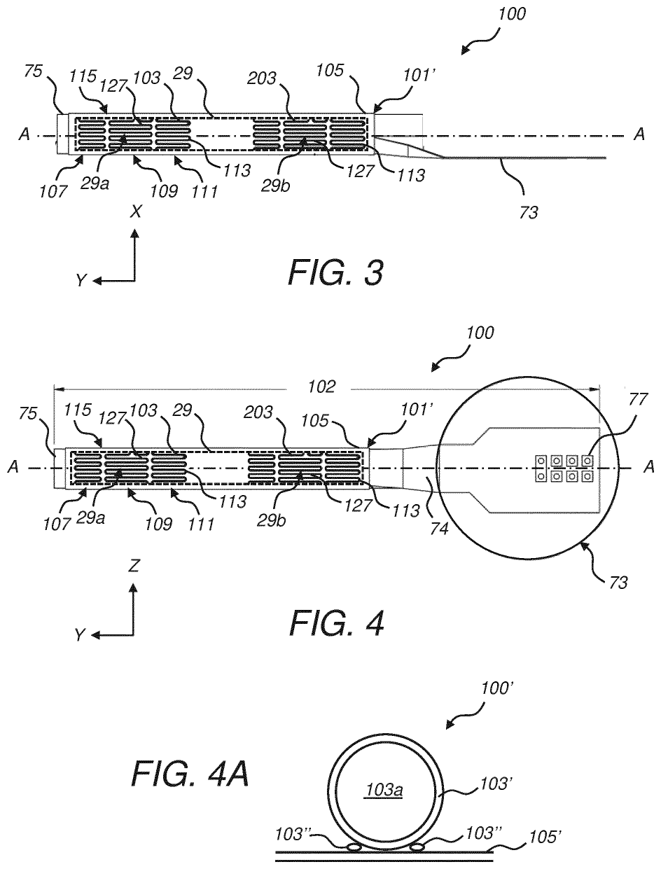

Referring to FIGS. 3 and 4, there is respectively shown a schematic first and second view of an assembly 100 for the aerosol provision device 1 of FIG. 1 according to an embodiment of the disclosure. The first view of FIG. 3 corresponds to the Z-axis direction. The second view of FIG. 4 corresponds to the X-axis direction.

The assembly 100 comprises a heating zone 29, as previously discussed, into which a consumable 21 comprising aerosol-generating material is inserted and is to be heated. In this embodiment, the consumable 21 is to be inserted into the heating zone 29 in a direction parallel to the longitudinal axis A-A of the heating zone 29. In this embodiment, the assembly 100 comprises a heating element shown as a support tube 75, as previously discussed. In other embodiments, the assembly 100 is provided without the support tube 75.

The assembly 100 comprises an electrical arrangement 101′ that comprises two electrically conductive tracks 103, 203 formed on an electrically insulating substrate 105. The tracks 103, 203 are an example of an electrically conductive path. The electrically insulating substrate 105 is a structure configured to provide support to the tracks 103, 203. In other embodiments, an electrically conductive wire may be used instead of an electrically conductive track.

In this embodiment, the substrate 105 is in the form of a sheet and comprises a plastics layer. The substrate 105 is rolled to form a tube. In this embodiment, the substrate is rolled around the support tube 75. As shown in FIGS. 3 and 4, the heater tail 73 rolls to some degree when the substrate 105 is rolled around the support tube 75. A first track 103 is formed on an electrically insulating substrate 105. In this embodiment, the tracks are formed by deposition on the substrate. In other embodiments the tracks are formed by printing on the substrate. In some embodiments, the first track 103 is electro-deposited onto the substrate 105. In other embodiments, the first track 103 is laminated onto the substrate 105. Electro-depositing the first track 103 is advantageous for cost saving reasons. Laminating the first track 103 represents a more reliable solution than electro-depositing the first track 103 on the substrate 105. When rolled around the support tube 75, the first track 103 conforms to the shape of the support tube 75 with minimal deviation from an external surface of the support tube 75. This helps provide efficient thermal transfer. In some instances, this additionally helps reduce a risk of damage the first track 103.

In other embodiments, the tracks are formed by an etching process. In some embodiments, the etching process corresponds to that used in the manufacture of printed circuit boards (PCBs). In some embodiments, the etching process comprises removing a material formed on a base layer by etching the material off the base layer. The unetched material, that is, the material that remains, is used to form the basis of the electrically conductive track. In some embodiments, the unetched material remains due to an etch resist coupled to a portion of the material, wherein the portion forms the basis of the electrically conductive track. In some embodiments, the unetched pattern may be formed by a photographic process.

In other embodiments, the electrically conductive path may be an electrically conductive wire 103a that is encapsulated by an electrical insulating element 103′, such as that shown in FIG. 4A. In such embodiments, the wire 103a is not formed by an etching process as described above. The wire 103a is enclosed by a sheath of electrical insulating material corresponding to electrical insulating element 103′, as shown in FIG. 4A and discussed below.

In this embodiment, the first and second tracks 103, 203 detect temperature of the heating zone 29 on the basis of an electrical resistance of the respective first and second tracks 103, 203. In other embodiments, the first and second tracks 103, 203 act as a heater to heat the heating zone 29 by resistance heating. In further embodiments, the first and second tracks 103, 203 detect the temperature of the heating zone 29 as a first function and heat the heating zone 29 as a second function. In the latter embodiment, the functions of the first and second tracks 103, 203 are interchangeable. In some embodiments, the first and second tracks 103, 203 perform the one of the first and second functions. In other embodiments, the first track 103 is configured to perform a different one of the first and second functions compared to the second track 203. When performing the function of detecting temperature, the track produces negligible heat that is insufficient to generate an inhalable medium. That is, the first function is incapable of producing aerosol from the aerosol-generating material.

The first track 103 is shown to extend along three distinct portions 107, 109, 111 of the substrate 105. In other embodiments, the first track 103 extends along at least two distinct portions 107, 109 of the substrate 105. The second track 105 is configured and arranged on the substrate 105 in the same manner but is spaced apart from the first track 103 so as to lie side-by-side with the first track 103 and not overlap with the first track 103. The distinct portions 107, 109, 111 of the substrate 105 provide for efficient coverage of the substrate 105 in both the longitudinal axis A-A direction and the circumferential direction of the heating zone 29. The use of distinct portions 107, 109, 111 of the substrate 105 allows for stress relief, particularly thermal stress relief.

The portions 107, 109, 111 of the first track 103 are distinct from each other because they are offset from each other by a gap 115. The gap 115 allows for movement of the first track 103 during expansion and contraction of the first track 103. The movement helps relieve mechanical stress on the first track 103 under working thermal conditions. For example, the working conditions comprise the temperatures experienced by the first track 103 when the first function of detecting temperature is performed or the second function of heating the heating zone 29 is performed. The gap 115 therefore assists in reducing stress within the first track 103 to avoid mechanical damage, which would affect the performance of the first track 103. The provides improved reliability because the risk of a track cracking is reduced. The gap 115 is shown in this view to be free of the first track 103. In other embodiments, the gap 115 is substantially free of the first track 103, wherein only a portion of the first track 103 that interconnects the distinct portions 107, 109, 111 of the substrate 105 exists in the gap 115.

The first and second tracks 103, 203 each comprises a multiplicity of turns 113. The multiplicity of turns 113 of the first track 103 are shown within each of the three distinct portions 107, 109, 111 of the substrate. In other embodiments, the assembly 100 may comprise a plurality of discrete portions. The second track 203 is arranged in the same manner. In the views shown in FIGS. 3 and 4, the multiplicity of turns 113 comprise turns that undergo an angle of rotation of 180 degrees. The multiplicity of turns 113 interconnect a multiplicity of straights, shown more clearly in FIG. 6. Each one of the multiplicity of straights is parallel to each other and extends in the longitudinal axis A-A direction. In some embodiments, a majority of the multiplicity of straights may be parallel to each other. In some embodiments, a majority of the multiplicity of straights may extend in the longitudinal axis A-A direction. Mechanical stress on the track is reduced when the multiplicity of straights extend in the longitudinal axis A-A direction, particularly when the heating zone 29 comprises a circular cross-section. The use of a multiplicity of turns minimizes alignment of the track in a non-linear direction, such as a circumferential direction. Minimizing the length of track that exists in a non-linear direction helps to reduce mechanical stress on the track to allow the track to reliably perform to an optimum level.

In this embodiment, the heating zone 29 comprises a first heating zone 29a and a second heating zone 29b, each corresponding to the first track 103 and second track 203, respectively. In this embodiment, the first track 103 is to detect a temperature of the first heating zone 29a and the second track 203 is to detect a temperature of the first heating zone 29b. In other embodiments, the first track 103 is to heat the first heating zone 29a and the second track 203 is to heat the first heating zone 29b.

In this embodiment, the first track 103 and second track 203 comprise a multiplicity of straights 127. Any one straight of the multiplicity of straights 127 extends only part way around the heating zone 29. The multiplicity of straights 127 help reduce stress on the tracks 103, 203 due to expansion of the tracks 103, 203, in use.

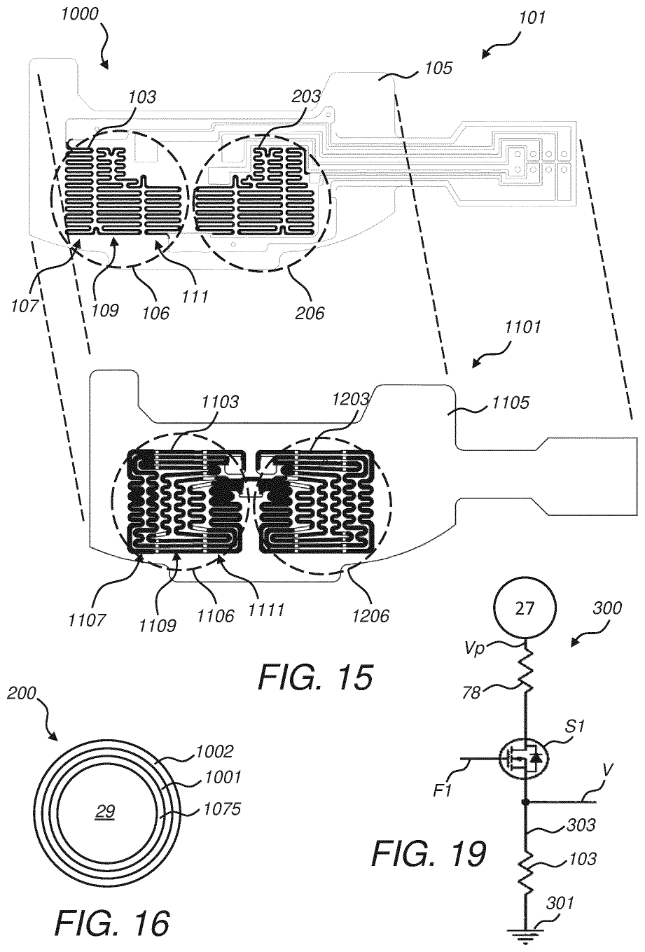

As best shown in FIG. 4, the substrate 105 comprises a heater tail 73 which passes outside of the support tube 75, as previously described. The heater tail 73 comprises electrical contacts 77 for connection with the control circuitry 25 shown in FIG. 2. The electrical contacts 77 comprise a first electrical connection between the first track 103 and the control circuitry 25, and a second electrical connection between the second track 203 and the control circuitry 25. When a second substrate layer is used, such as the second substrate 1101, shown in FIG. 15 and discussed below, the electrical contacts 77 comprise a third electrical connection between a first outer track 1103 and the control circuitry 25, and a fourth electrical connection between a second outer track 1203 and the control circuitry 25. The heater tail 73 comprises a connection portion 74 which extends from the heating zone 29 and is a constriction compared to the region of the heater tail 73 that comprises the electrical contacts 77. The heater tail 73 is shown in a flat configuration in FIGS. 3 and 4 and is bent when installed in the apparatus 1 shown in FIGS. 1 and 2. The assembly 100 therefore comprises a length 102 which is reduced when installed in the apparatus 1.

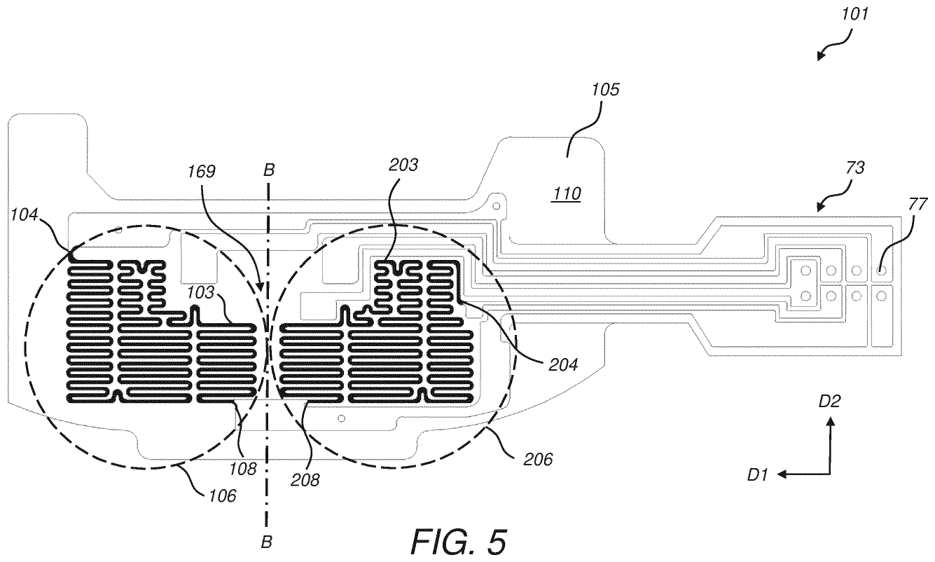

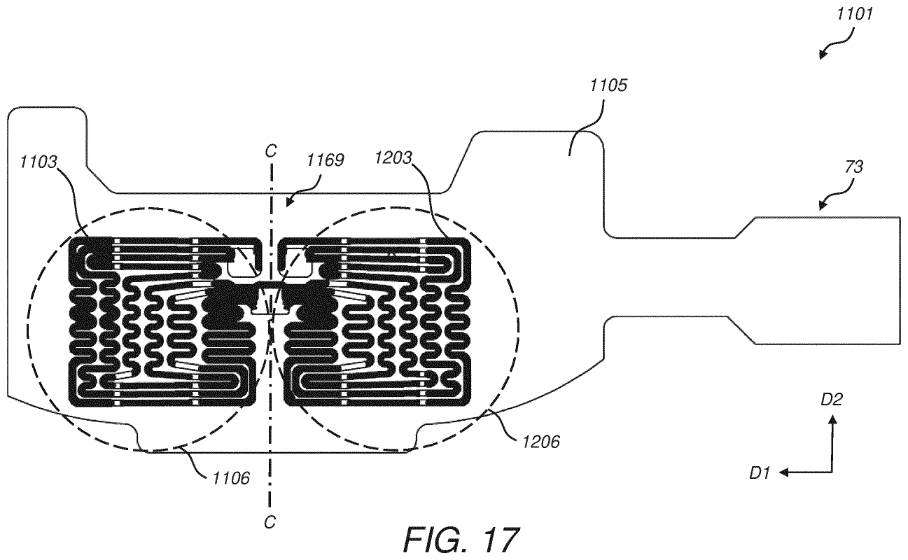

Referring to FIG. 4A, a schematic cross-sectional view of an alternative assembly 100′ is shown. The assembly 100′ of FIG. 4A is different to the assembly 100 of FIGS. 3 and 4 in that a wire 103a is used instead of the first track 103. The wire 103a is an example of an electrically conductive path. Features described herein in relation to the arrangement of the track, except for the etching process, apply to embodiments wherein the path is a wire 103a. That is, features of tracks 103, 203, 1103, 1203 of electrical arrangements 101, 1101 as shown respectively in FIGS. 5 and 17 also apply when the path is a wire 103a.

The wire 103a is encapsulated by an electrically insulating element 103′ instead of being formed on the electrically insulating substrate 105. The wire 130a, encapsulated by the electrically insulating element 103′, is affixed to a structure 105′ by a fixing member 103″. In this embodiment, the fixing member 103″ is an adhesive. In other embodiments, the fixing member 103″ may be a mechanical coupling. In some embodiments, the structure 105′ may be an electrically conducting element. For example, in some embodiments, the structure 105′ may correspond to the support tube 75. In this embodiment, the wire 103a comprises a circular cross-section along substantially an entire length of the wire 103a.

Referring to FIG. 5, there is illustrated a schematic view of an electrical arrangement 101 which is a particular example of the electrical arrangement 101′ illustrated in the assembly 100 illustrated in FIGS. 3 and 4. Features already described with respect to FIGS. 3 and 4 are given the same reference numerals in FIG. 5 as they are in FIGS. 3 and 4.

The electrical arrangement 101 is illustrated in a flat configuration in FIG. 5. The electrical arrangement 101 is suitable for rolling around the support tube 75 to provide the tube configuration as shown in FIGS. 3 and 4. In some embodiments, the heater tail 73 rolls to some degree when the substrate 105, on which the tracks 103, 106 are formed, are rolled around the support tube 75. In other embodiments, only a connection portion 74 of the heater tail 73 rolls to some degree when the substrate 105 on which the tracks 103, 106 are rolled around the support tube 75. In other embodiments, the heater tail 73 is configured to roll around the support tube 75. In some embodiments, the heater tail 73 is provided approximately 90 degrees to the orientation shown in FIG. 4. That is, the heater tail 73 is provided approximately 90 degrees about the X-axis direction or the Z-axis direction.

Both of the first and second tracks 103, 203 are provided on the same side 110 of the substrate 105. In this embodiment, the first and second tracks 103, 203 are deposited on the same surface of the substrate 105. Although this surface is shown in a flat configuration, when the electrical arrangement 101 is provided as part of an assembly 100, as shown in FIGS. 3 and 4, the surface is arcuate because the substrate 105 is rolled around the support tube 75. In the embodiment of FIGS. 3 and 4, the heating zone 29 comprises a circular cross-section so that surface therefore becomes circular. The flat configuration allows for the first and second tracks 103, 203 to be best shown for discussion purposes.

As shown in FIG. 5, the first track 103 is arranged on the substrate 105 in a first region 106 and the second track 203 is arranged on the substrate 105 in a second region 206. The first and second regions 106, 206 are shown, for explanatory purposes, by dashed circles. The portion of the tracks 103, 203 in the first and second regions 106, 206 is shown, for explanatory purposes, by bold lines. The first and second regions 106, 206 are offset from one another by a gap 169. The gap 169 between the first and second regions 106, 206 is greater than the gap 115 between the distinct portions 107, 109 of the first track 103 shown in FIGS. 3 and 4. The larger gap 169 allows for a clear separation of temperature detection zones or heating zones. The larger gap 169 therefore establishes two different zones and reduces the effect of one zone on the other zone. In this embodiment, the larger gap 169 is free of the first track 103 and the second track 105. This helps to reduce or avoid interference between the first and second regions 106, 206.

The second track 203 is shown as substantially a mirror image of the first track 103 about an imaginary line B-B between the first track 103 and second track 203. For example, at least one of the distinct portions of the first and second tracks 103, 203 are near identical and the other two distinct portions comprise sub-portions that are near identical. In other embodiments, the second track 203 may not be a mirror image of the first track 103, as long as a center of each of the first and second regions 106, 206 is correctly positioned.

As shown in FIG. 5, a majority of straights of the first and second tracks 103, 203 extend in a first direction D1 that is intended for alignment with the longitudinal axis A-A of the assembly 100. This allows the majority of straights to be aligned with the longitudinal direction Y of the heating zone 29 since this is intended to be parallel to the longitudinal axis A-A of the assembly 100 when the assembly 100 is installed in the apparatus 1. A second direction D2 is shown perpendicular to the first direction D1. In this embodiment, a minority of straights extend in the second direction D2.

Each of the first and second tracks 103, 203 in the respective first and second regions 106, 206 comprise a first portion 104, 204 that corresponds to either a first turn or first straight of the first and second regions 106, 206. Likewise, each of the first and second tracks 103, 203 in the respective first and second regions 106, 206 comprise a second portion 108, 208 that corresponds to either a last turn or last straight of the first and second regions 106, 206.

Referring to FIG. 6, a schematic enlarged view of one of the electrically conductive tracks 103, 105 shown in FIG. 5 according to an embodiment of the disclosure is shown. The one of the tracks 103, 105 is the first track 103, for exemplary purposes.

An arrangement of the multiplicity of turns 113 and straights 127 of the first track 103 varies in each of the distinct portions 107, 109, 111 by a number of the turns 113 and straights 127 and by a length of each straight 127.

A first one of the distinct portions 107, herein referred to as a first distinct portion 107, is shown by short-dash lines. A second one of the distinct portions 109, herein referred to as a second distinct portion 109, is shown by long-dash lines. A third one of the distinct portions 111, herein referred to as a third distinct portion 111, is shown by dash-dot lines.

Each one of the short-dash, long-dash, and dash-dot lines represents a boundary 107′, 109′, 111′ of each one of the respective distinct portions 107, 109, 111. In this embodiment each boundary 107′, 109′, 111′ is in the shape of a rectangle. In other embodiments, other arrangements are possible. Each boundary 107′, 109′, 111′ is therefore formed of four boundary lines that are each parallel to another boundary line.

The first distinct portion 107 comprises a first to fourth boundary line 107a-d. The second distinct portion 109 comprises a first to fourth boundary line 109a-d. The third distinct portion 111 comprises a first to fourth boundary line 111a-d.

The first 107a, 109a, 111a and third 107c, 109c, 111c boundary lines of each of the distinct portions 107, 109, 111 are parallel to each other, and perpendicular to the second 107b, 109b, 111b and fourth 107d, 109d, 111d boundary lines.

The boundary lines demarcate an extent of each distinct portion. In some embodiments, the boundary lines 107a-d, 109a-d, 111a-d abut edges of the track. In some embodiments, each boundary 107′, 109′, 111′ defines the smallest size possible quadrilateral (for example a square or rectangle) to enclose the distinct portions of the track and define the gap 115, 117. Applying this to the embodiment of FIG. 6 would mean that the first 107a, 109a and third 107c, 109c, boundary lines of the first 107 and second 109 distinct portions would abut and extend along straights 127 positioned at the end of the respective first 107 and second 109 distinct portions. Equally, this would mean that the second 107b, 109b, 111b and fourth 107d, 109d, 111d boundary lines of the first to third distinct portions 107, 109, 111 would abut and extend tangentially to a majority of the turns of the multiplicity of turns 127 positioned at edges of the respective first to third 107, 109, 111 distinct portions.

In this embodiment, one distinct portion 109 is adjacent two other distinct portions 107, 111. Furthermore, the first and second distinct portions 107, 111 are each adjacent the second distinct portion 109. The first distinct portion 107 is separated from the second distinct portion 109 by a first gap 115, and the second distinct portion 109 is separated from the third distinct portion 111 by a second gap 117. The first gap 115 and second gap 117 have the same width. In other embodiments, the gaps 115, 117 may have different widths but be greater than a spacing between the straights 127.

In the embodiment shown, a size of the second boundary 109′ is the smallest amongst the three boundaries 107′, 109′, 111′. The second boundary 109′ is shown to have the greatest width, whereas the first boundary 107′ is shown to have the smallest width. The first and second boundaries 107′, 109′ have the same length and are both longer than a length of the third boundary 111′.

Each length and width direction of the distinct portions 107, 109, 111 are parallel to each other distinct portion 107, 109, 111. That is, there is no angle of rotation between the distinct portions 107, 109, 111.

The arrangement of the multiplicity of turns 113 and straights 127 of the first track 103 varies in each of the distinct portions 107, 109, 111. The first track 103 follows a convoluted pathway. The convoluted pathway comprises 90 degree and 180 degree turns that are mostly spaced by straights. In some embodiments, the convoluted pathway comprises turns comprising anything greater than 0 degree and less than 180 degrees. The convoluted pathway essentially forms two types of repeated patterns in each distinct portion 107, 109, 111.

A first repeated pattern includes straights 127 that extend the entire width of the portions 107, 109, 111 from one boundary line 107b, 109b, 109b to another boundary line 107d, 109d, 111d. The first repeated pattern extends includes substantially all of the 180 degree turns of the first track 103 in the first 107 and third 111 portions and along more than 70% of the width of the respective portions 107, 111. The first repeated pattern extends along less than 70% of the width of the second distinct portion 109.

A second repeated pattern includes straights 127 that extend only part way along the width of the second distinct portion 109 from one boundary line 107b, 109b to another boundary line 107d, 109d. The second repeated pattern is only shown in the second distinct portion 109 and exists closer to the first boundary line 109a than the third boundary line 109c.

The convoluted pathway of the first track 103 extends from the first portion 104 to the second portion 108. The first portion 104 comprises a straight 127 and the second portion 108 comprises a turn 113. The first portion 104 exists at a first end 107a′ of the first distinct portion 107. The first track 103 winds side-to-side in direction D2 and from end-to-end in direction D1 in the first distinct portion 107. The first track 103 winds from the first portion 104 to and from a first side 107b′ and second side 107d′ and towards a second end 107c′ opposite the first end 107a′. The first track 103 also winds side-to-side in direction D2 and from end-to-end in direction D1 in the third distinct portion 111 from a first end 111a′ to a second end 111c′ and between a first side 111b′ and second side 111d′ to the second distinct portion 108. The first track 103 winds side-to-side in direction D2 and from end-to-end in direction D1 in the second distinct portion 109. However, the winding begins at a second side 109d′ and finishes at a first side 109b′ and extends between a second end 109c′ and first end 109a′.

Each of the first ends 107a′, 109a′, 111a′ and second ends 107c′, 109c′, 111c′ may be referred to as sides, in that the first track 103 extends to and crosses different sides of the distinct portions 107, 109, 111 of the substrate 105.

FIG. 6 shows two connection portions 151, 153 of the first track 103 that interconnect the first to third distinct portions 107, 109, 111. Also shown in FIG. 6 are stress-relief features 139, 140 of the first track 103 that are shown as a localized loop-back to reduce mechanical stress as the first track 103 expands and contracts under thermal energy. Each connection portion 151, 153 and stress-relief feature 139, 140 appears as either a protuberance 140, 153 or a recess 139, 141, 151 when viewing the first track 103 in a flat configuration from above. The protuberance 140, 153 is a portion of the first track 103 that projects away from a center of the gap 117. That is, the protuberance 140, 153 is an external facing turn that faces away from a center of the gap 117. The recess 139, 141, 151 is a portion of the first track 103 that projects towards the center of the gap 117. That is, the recess 139, 141, 151 is an internal facing turn that faces towards from a center of the gap 117. An example of the recess is shown by a first area 159 of the first track 103. An example of the protuberance is shown by a second area 161 of the first track 103. The first 159 and second areas 161 are discussed further below. Each of the protuberance 140, 153 or recess 139, 141, 151 is considered as a localized deviation from a main pathway either side of the protuberance 140, 153 or recess 139, 141, 151.

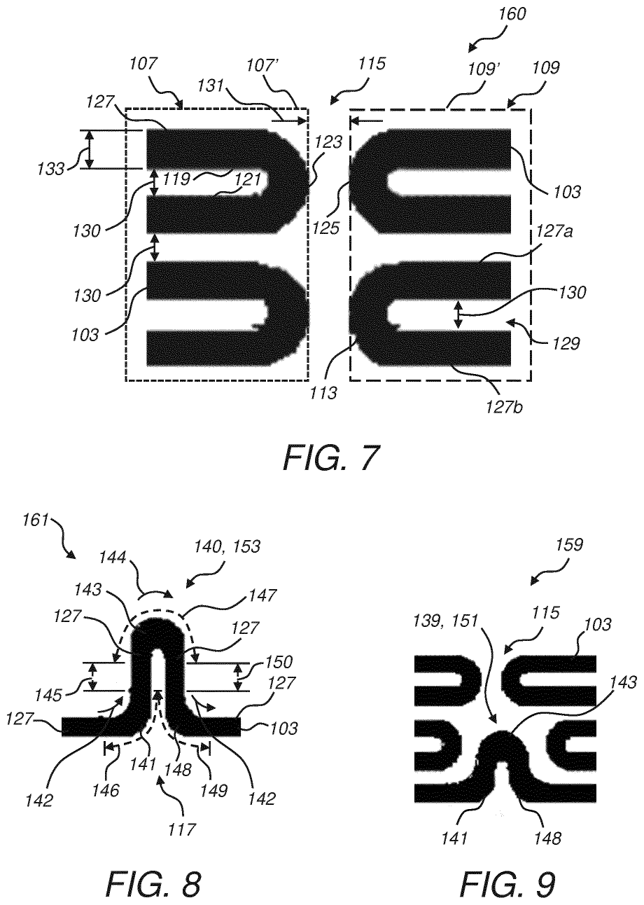

Referring to FIG. 7, a schematic enlarged view of a third area 160 of the first track 103 according to an embodiment of the disclosure is shown. The third area 160 is an area between the first and second distinct portions 107, 109 that do not directly connect. The third area 160 is shown in FIG. 6 in relation to other parts of the first track 103.

The third area 160 shows part of the gap 115 between part of the track 103 in the first distinct portion 107 and part of the track 103 in the second distinct portion 109. The gap 115 is shown with a size 131 that is represented by a width. In some embodiment, the size of the gap 115 may refer to a length of the gap 115. The width 131 of the gap 115 is substantially the same as a width 133 of each straight 127. In other embodiments, the size 131 (for example a width) of the gap 115 may be greater than a width 133 of each straight 127 and smaller than double the width 133 of each straight 127. In some embodiments, each straight 127 my only comprise straights 127 adjacent the gap 115 and other straights 127 may be thicker than the gap 115.

In this embodiment, the width 133 of each straight 127 is approximately 0.3 mm.

As shown in FIG. 7, the first boundary 107′ and second boundary 109′ extends to edges 123, 125 of the turns 113 so that boundary lines are tangential with the turns 113. This means the gap 115 extends to the turns 113 within each of the first distinct portions 107 and second distinct portion 109 of the substrate 105.

A size 130 of a spacing 129 between adjacent straights 127a, 127b of the track 103 is less than a size 131 of the gap 115, such as a width 131 of the gap. In this embodiment, the size of the spacing 129 is a width 130 of the spacing 129. In this embodiment, the width 130 of the spacing 129 is less than the width 133 of each straight 127. In this embodiment, the width 130 of the spacing 129 is approximately 0.2 mm.

Adjacent edges 119, 121 of the first track 103 are closer to each other within each of the first and second distinct portions 107, 109 of the substrate 105 compared to adjacent edges 123, 125 of the first track 103 between the first and second distinct portions 107, 109 of the substrate 105. In this embodiment, the adjacent edges 119, 121 that are relatively closer are adjacent edges of the straights 127 and the adjacent edges 123, 125 that are relatively further apart are adjacent edges of the straights turns 113.

Referring to FIG. 8, a schematic enlarged view of a second area 161 of the first track 103 according to an embodiment of the disclosure is shown. The second area 161 is an area between the second and third distinct portions 109, 111 that directly connect. In this embodiment, the second area 161 shows a connection portion 153 as a protuberance. The connection portion 153 spans the second gap 117. In this embodiment, the connection portion 153 doubles as a stress-relief feature 140 and may be referred to as either a connection portion 153 or a stress-relief feature 140. The second area 161 is shown in FIG. 6 in relation to other parts of the first track 103.

The stress-relief feature 140 comprises a first turn 141 in a first direction 142, followed by a second turn 143 in a second direction 144 and a third turn 148 in the first direction 142. In this embodiment, the first direction 142 is an anti-clockwise direction and the second direction 144 is a clockwise direction. The first and third turns 141, 148 are 90 degree turns in that the first track 103 exits one straight 127 and undergoes an angle of rotation of 90 degrees through the first and third turns 141, 148 before entering another straight 127. The second turn 143 is a 180 degree turn in that the first track 103 exits one straight 127 and undergoes an angle of rotation of 180 degrees through the second turn 143 before entering another straight 127. The turns in the stress-relief feature 140 allow the stress-relief feature 140 to be space efficient. Additionally, each turn is able to expand in an arcuate manner rather than a linear manner. This provides for improved contraction and expansion.

A length 145 of the first track 103 between the first turn 141 and second turn 143 is less than a length 146, 147 of both one the first turn 141 and second turn 143. In this embodiment, the length 145 is a length of a straight 127. A length 150 of the first track 103 between the second turn 143 and third turn 148 is less than a length 147, 149 of both the second turn 143 and third turn 148. In this embodiment, the length 150 is a length of a straight 127. In some embodiments, the length 145, 150 of the straight 127 away from the second turn 143 may be zero or at least negligible compared to the length 147 of the second turn 143.

Referring to FIG. 9, a schematic enlarged view of a first area 159 of the first track 103 according to an embodiment of the disclosure is shown. The first area 159 is an area between the first and second distinct portions 107, 109 that directly connect. In this embodiment, the first area 159 shows a connection portion 151 as a recess. The connection portion 153 spans the first gap 115. In this embodiment, the connection portion 151 doubles as a stress-relief feature 139 and may be referred to as either a connection portion 151 or a stress-relief feature 139. The first area 159 is shown in FIG. 6 in relation to other parts of the first track 103.

Much like the stress-relief feature 140 shown in FIG. 8, the stress-relief feature 139 shown in FIG. 9 comprises a first turn 141 in the first direction 142, followed by a second turn 143 in the second direction 144 and a third turn 148 in the first direction 142. The difference between the stress-relief feature 140 shown in FIG. 8 and the stress-relief feature 139 shown in FIG. 9 is that the stress-relief feature 139 shown in FIG. 9 comprises no straight either side of the second turn 143. That is, the stress-relief feature 139 shown in FIG. 9 is comprises of three turns joined together. This allows the stress-relief feature 139 to be compact.

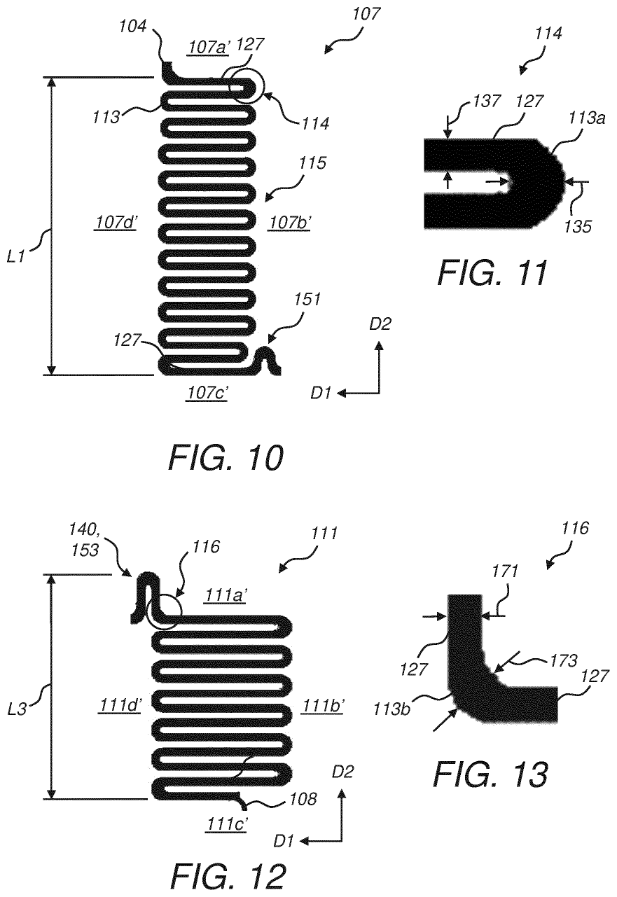

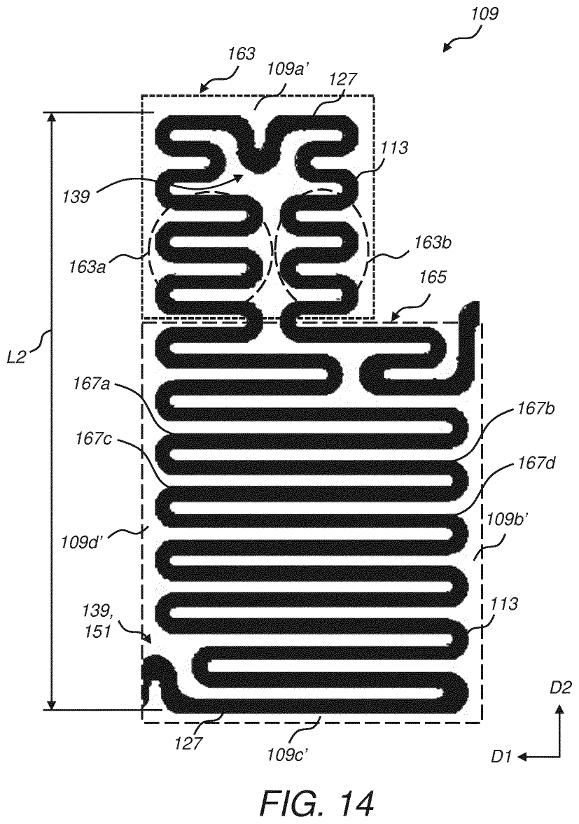

Referring to FIG. 10, a schematic enlarged view of the first distinct portion 107 of the first track 103 is shown. The first distinct portion 107 comprises a length L1 between the first end 107a′ and second end 107c′. The length L1 of the first distinct portion 107 is the same as a length L2 of the second distinct portion 109, as shown in FIG. 14. Both lengths L1, L2 of the first and second distinct portions 107, 109 are measured between outermost edges of the outermost straights 127. The first distinct portion 107 is shown to comprise an array of rows in a single column. The rows are defined by the multiplicity of straights 127. A width of the single column is shown as the distance between adjacent turns 113.

Referring to FIG. 11, a schematic enlarged view of a fourth area 114 of the first track 103 shown in FIG. 10 comprising a 180 degree turn 113a is shown. The 180 degree turn 113a is arcuate. The 180 degree turn 113a is a semi-circle turn in that the turn substantially comprises a semi-circle. The 180 degree turn 113a may be understood as a full U-bend. A width 135 of the track 103 within the 180 degree turn 113a is greater than a width 137 of the track 103 outside of the 180 degree turn 113a. That is, a width 137 of the straight 127 is less than a width of the 180 degree turn 113a. The width 135 of the 180 degree turn 113a is measured at the mid-point of the 180 degree turn 113a, corresponding to a location of 90 degrees through the 180 degree turn 113a. The width 135 at the mid-point of the 180 degree turn 113a corresponds to a maximum width. In this embodiment, the width 135 of the 180 degree turn 113a is approximately 0.5 mm. In this embodiment, the width 137 of the straight 127 is approximately 0.3 mm. The first track 103 widens towards and away from the mid-point of the 180 degree turn. Generally, the 180 degree turn 113a is wider than the straight 127 to relieve mechanical stress on the first track 103 in the 180 degree turn 113a. Providing a turn with a greater thickness than a straight improved adhesion of the turn to the substrate because a contact area is increased.

Referring to FIG. 12, a schematic enlarged view of the third distinct portion 111 of the first track 103 is shown. The third distinct portion 111 comprises a length L3 between the first end 111a′ and second end 111c′. The length L3 of the third distinct portion 111 is less than the length L1 of the first distinct portion 107 and the length L2 of the second distinct portion 109. The length L3 of the third distinct portion 111 is measured between an outermost edge of the turn 113 proximal the first end 111a′ and an outermost edge of the outermost straight 127 proximal at the second end 111c′.

Referring to FIG. 13, a schematic enlarged view of a fifth area 116 of the first track 103 shown in FIG. 10 comprising a 90 degree turn 113b is shown. The 90 degree turn 113b is arcuate. The 90 degree turn 113b is a quarter-circle turn in that the turn substantially comprises a quarter-circle. The 90 degree turn 113b may be understood as a half U-bend. A width 173 of the track 103 within the 90 degree turn 113b is greater than a width 171 of the track 103 outside of the 90 degree turn 113b. That is, a width 171 of the straight 127 is less than a width of the 90 degree turn 113b. The width 173 of the 90 degree turn 113b is measured at the mid-point of the 90 degree turn 113b, corresponding to a location of 45 degrees through the turn 113b. The width 173 at the mid-point of the turn 113b corresponds to a maximum width. In this embodiment, the width 173 of the 90 degree turn 113b is approximately 0.45 mm. In this embodiment, the width 171 of the straight 127 is approximately 0.3 mm. The first track 103 widens towards and away from the mid-point of the 90 degree turn 113b. Generally, the 90 degree turn 113b is wider than the straight 127 to relieve mechanical stress on the first track 103 in the 90 degree turn 113b.

Referring to FIG. 14, a schematic enlarged view of the second distinct portion 109 of the first track 103 is shown. The second distinct portion 109 comprises a first sub-portion 163 and a second sub-portion 165. Each sub-portion 163, 165 may be referred to as a region. As shown in FIG. 14, a number of turns 113 per unit length of the first track 103 within the second distinct portion 109 of the substrate 105 is different in the first sub-portion 163 compared to the second sub-portion 165. In the embodiment shown, the unit length of the first track 103 within the first sub-portion 163 exceeds the unit length of the first track 103 within the second sub-portion 165. The first sub-portion 163 comprises a first part 163a and a second part 163b. A number of turns 113 per unit length of the first track 103 between the first and second parts 163a, 163b also varies, wherein the unit length of the first track 103 within the second part 163b exceeds the unit length of the first track 103 within the first part 163a. In other embodiments, the unit length of the first and second parts 163a, 163b may be equal. That is, the first and second parts 163a, 163b may be a mirror image of each other. As shown in FIG. 14, the first track 103 in the first sub-portion 163 enters and exits the first sub-portion 163 at the same end. In other embodiments, the first sub-portion 163 may enter and exit at different ends or sides of the first sub-portion 163 or one end and one side of the first sub-portion 163. In this embodiment, the first track 103 of the sub-portion 163 effectively forms two columns and eight rows. In other embodiments, the first track 103 of the sub-portion 163 may form more than two columns and/or less than eight rows.

In this embodiment, a width of the second sub-portion 165 is greater than a width of the first sub-portion 163. Adjacent straights 167a-d are parallel to teach other and are arranged in a row arrangement. Each of the adjacent straights 167a-d have the same width.

Referring to FIG. 15, a schematic view of a layered electrical arrangement 1000. The layered electrical arrangement 1000 comprises a first electrical arrangement 101 corresponding to the electrical arrangement 101 of FIG. 5 and a second electrical arrangement 1101. The second electrical arrangement 1101 comprises electrically conductive tracks 1103, 1203 for the device 1 of FIG. 2. The second electrical arrangement 1101 is arranged to be overlaid onto the first electrical arrangement 101 according to an embodiment of the disclosure.

The second electrical arrangement 1101 comprises a second substrate 1105 and a first outer track 1103 and a second outer track 1203. The second substrate 1105 is a structure configured to provide support to the tracks 1103, 1203. The first outer track 1103 and second outer track 1203 may be referred to as third and fourth tracks, respectively. As shown by the diagonally dashed lines, the second electrical arrangement 1101 is for combination with the first electrical arrangement 101 by overlaying the second electrical arrangement 1101 on top of the first electrical arrangement 101. The first and second electrical arrangements 101, 1101 may be overlaid prior to rolling them as a combination around the support tube 75. The second electrical arrangement 1101 comprises at least two distinct portions 1107, 1109, 1111 in a first outer region 1106 and a second outer region 1206 as shown in relation to the first electrical arrangement 101. The first outer region 1106 and second outer region 1206 may be referred to as third and fourth regions, respectively.

In other embodiments, the first outer path, shown as a first outer track 1103, and/or the second outer path, shown as a second outer track 1203, may be in the form of an electrically conductive wire. In some embodiments, each wire is encapsulated by an electrically insulating element 103′, as shown in and explained above in relation to FIG. 4A, instead of being formed on the second electrically insulating substrate 1105. In this instance, the structure 105′ is provided by a component other than the second electrically insulating substrate 1105. Such an arrangement may comprise any of the features described in relation to FIG. 4A above.

In this embodiment, the tracks 103, 203 on the first electrical arrangement 101 are to perform a different one of the first and second functions to the tracks 1103, 1203 on the second electrical arrangement 1101. In this embodiment, the first electrical arrangement 101 is to perform the first function of detecting temperature of the heating zone 29 and the second electrical arrangement 110 is to perform the second function of acting as a heater to heat the heating zone 29 by resistance heating. The first electrical arrangement 101 may therefore be referred to as a temperature sensor.

Further referring to FIG. 16, a schematic cross-section of an assembly 200 comprising substrate layers 1001, 1002 according to an embodiment of the disclosure is shown, wherein each substrate layer 1001, 1002 comprises electrically conductive tracks for the device 1 of FIG. 2. Each substrate layer 1001, 1002 is a structure layer. A first substrate layer 1001 corresponds to the first electrical arrangement 101 and a second substrate layer 1002 corresponds to the second electrical arrangement 1101. As shown in FIG. 16, the second substrate layer 1002 overlaps the first substrate layer 1001 and both substrate layers 1001, 1002 wrap around a third layer 1075 comprising the support tube 75. In other embodiments, the order of the substrate layers 1001, 1002 may be reversed in that the first substrate layer 1001 is provided above the second substrate layer 1002. In some embodiments, the electrically conductive paths are electrically conductive wires and encapsulated by at least one electrically insulating element 103′. In such embodiments, the structure may be a component other than an electrically insulating substrate.

Referring to FIG. 17, a schematic view of the second electrical arrangement 1101 is shown. The second electrical arrangement 1101 comprises two electrically conductive tracks 1103, 1203 formed on the electrically insulating substrate 1105 and offset by a gap 1169 that is substantially free of the tracks. In this embodiment the third and fourth tracks 1103, 1203 are wider than the first and second tracks 103, 203 due to a greater current being passed through the third and fourth tracks 1103, 1203 to establish the resistance heating effect. In other embodiments, the second electrical arrangement 1101 may not be provided in that the heating method used in another embodiment is induction heating, for example. The third and fourth tracks 1103, 1203 are substantially a mirror image of one another about an imaginary line C-C. In other embodiments, a mirror image is not used.

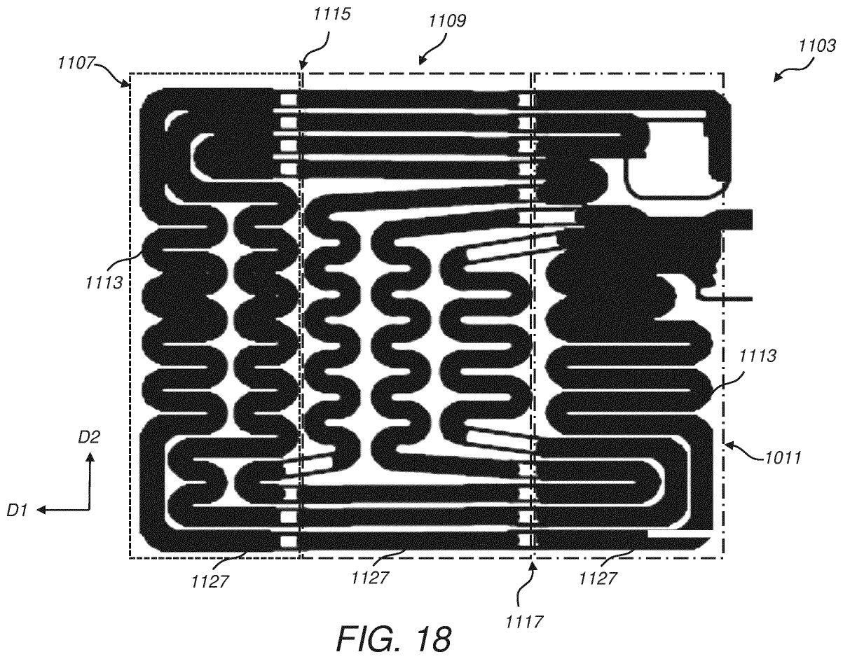

Referring to FIG. 18, a schematic enlarged view of the third track 1103 is shown. The third track 1103 comprises a multiplicity of turns 1113 and straights 1127. Furthermore, as with the first track 103, three distinct portions 1107, 1109, 1111 are shown that are each separated by a gap 1115, 1117.

The functionality of the first function, as referred to above, is discussed in further detail below in relation to the first track 103 and second track 203.

The controller 81, shown in FIG. 2, is configured and arranged to control a supply of power from the power source 27 to the first track 103 and second track 203. The supply of power to each track 103, 203 is independent of each other when performing the first function.

The detector 83 detects an electrical resistance of each track 103, 203.

The detector 83 is configured to take a sample of the electrical resistance of each of the first track 103 and second track 203 for a predetermined duration. In this embodiment, the predetermined duration is approximately 250 μs (0.25 ms). In some embodiments, the predetermined duration is less than 1 ms. In some embodiments, the predetermined duration is less than 0.5 ms. In some embodiments, the predetermined duration is between 0.1 ms and 0.4 ms.

The detector 83 is further configured to take multiple samples of the electrical resistance of each of the first track 103 and second track 203 at a predetermined sampling rate (sometimes referred to as an interrupt rate). The frequency of the interrupt rate in this embodiment is approximately 100 Hz. In some embodiments, the frequency of the interrupt rate is less than 1 kHz. In some embodiments, the frequency of the interrupt rate is less than 500 Hz. In some embodiments, the frequency of the interrupt rate is between 1 Hz and 500 Hz. In some embodiments, the frequency of the interrupt rate is between 10 Hz and 200 Hz.

FIG. 19 is a diagram of a first circuit 300 which, in this example, is used by the detector 83 to take a sample of the electrical resistance of the first track 103 in each predetermined duration. The circuit 300 comprises a first resistor 78 of known resistance R1, an electronic switch 51 and the first track 103 all arranged in electrical series with the switch 51 between the first resistor 78 and the first track 103. In this example, the electronic switch 51 is an N channel MOSFET, although any suitable electronic switch could be used. The first track 103 has a first end connected to ground and a second end connected to the source terminal of the MOSFET S1. The first resistor 78 has a first end connected to the drain terminal of the MOSFET S1 and a second end connected to a voltage Vp from the power source 27.

The controller 81 controls the gate terminal of the MOSFET S1 with control signal F1 to turn the MOSFET S1 ON for each predetermined duration (as indicated above, for example, 250 μs). When the MOSFET S1 is ON, the detector 83 measures a voltage V at the second end of the first track 103 and determines a current flowing through the circuit 300 (i.e. the current through the first resistor 78, MOSFET S1 and the first track 103 to ground) in accordance with Ohm's law using the expression:

Current=(Vp−Measured voltage V)/R1

The detector 83 determines a first resistance R2 corresponding to the resistance of the first track 103 in accordance with Ohm's law using the expression:

R2=Measured voltage V/Current

This calculation is based on the assumption that the resistance of the MOSFET S1 is very much smaller than the resistance R1 of the first resistor 78 and can be safely disregarded when calculating the current. Of course, the resistance of the MOSFET S1 could be taken account of simply by adding an assumed value for that resistance to the resistance R1 of the first resistor 78 in the expression used to calculate the current.

In some examples, the voltage Vp from the power supply 27 may vary and should also be measured by the detector 31 rather than taken as a constant. In other examples, the voltage Vp from the power supply is taken as a constant.

It should be appreciated that a corresponding second circuit (not illustrated) is used by the detector 83 to determine a second resistance corresponding to the resistance of the second track 103.

In some examples and depending upon measurement set up, the determined first and second resistances may comprise a contribution from resistance of track that is actually outside of both of the respective first and second tracks 103, 203, for example track that is comprised on the tail 73. Using predetermined information about the track outside of the first and second tracks 103, 203, the detector 83 or controller 81 is configured to take account of the resistance caused by the track outside of the first and second tracks 103, 203 to provide final first and second resistances. That is, the detector 83 or controller 81 is configured to calculate an electrical resistance of a portion of the track away from the heating zone, on the basis of predetermined information about the portion. The predetermined information may comprise known physical information about the track outside of the first and second tracks 103, 203, for example the known length, thickness and width of the track. In some examples it may be assumed that the resistance of the track outside of the first and second tracks 103, 203 is a fixed proportion of the total resistance and the detector 83 may subtract this fixed proportion from the measured total resistance to obtain a value of the resistance of either the first and second tracks 103, 203 as the case may be.

Once the resistances are known, the controller 81 is configured to calculate the temperature of each respective region using the temperature coefficient of resistance of the track and the known resistance of the respective track at a known temperature. The temperature coefficient of resistance of copper is 0.004041 per degrees Celsius at a known temperature of 20 degrees Celsius, for example. The following equation is used to determine the unknown temperatures:

R=Rref[1+α(T−Tref)]

wherein: R=unknown resistance of track, Rref=known resistance of track at known temperature, α=temperature coefficient of resistance of track (for example copper), T=unknown temperature of track, and Tref=known temperature at which a is taken.

As explained above, in some embodiments, the first and second outer tracks 1103, 1203 are overlaid onto the first 103 and second tracks 203. In some embodiments, the first and second tracks 103, 203 are used in the first function and the first and second outer tracks 1103, 1203 are used in the second function. In such circumstances, a correction factor may be needed to account for a temperature contribution by the second outer track 1203 on the track outside of the first track 103, specifically on the tail 73 due to the proximity of the tail 73 to the second outer track 1203, as shown in FIG. 15. A correction factor may therefore be applied to the final first resistance to account for the temperature influence of the second outer track 1203 on the track outside of the first track 103.

A correction comprises determining a correction amount based on a temperature differential between the first outer region 1106 and the second outer region 1206. The correction amount is a reduction of the temperature of the first outer region 1106. The correction amount is calculated by applying a correction factor to the temperature differential. The correction factor may be approximately 90 millidegrees Celsius. Therefore, for each degree Celsius of the temperature differential, a reduction of 90 millidegrees Celsius is to be applied. The correction amount is the temperature differential in degrees Celsius multiplied by the correction factor. Reducing a detected temperature of the first outer region 1106 by the correction amount provides a more accurate temperature reading that accounts for the influence of the second outer track 1203 on the track outside of the first track 103, specifically on the tail 73 due to the proximity of the tail 73 to the second outer track 1203, as shown in FIG. 15. Therefore, the temperature of the heating zone is calculated on the basis of the electrical resistance of the track and an electrical resistance of the portion of the track away from the heating zone.

In some embodiments, the aerosol-generating material is non-liquid aerosol-generating material, and the apparatus is for heating non-liquid aerosol-generating material to volatilize at least one component of the aerosol-generating material.

Any features described herein in relation to the arrangement of the electrically conductive track, except for the etching process, apply to embodiments wherein the electrically conductive path is an electrically conductive wire.

In some embodiments, the consumable 21 is an article comprising or consisting of aerosol-generating material, part or all of which is intended to be consumed during use by a user. Once all, or substantially all, of the volatilizable component(s) of the aerosol-generating material in the consumable 21 has/have been spent, the user may remove the consumable 21 from the heating zone 29 of the apparatus 1 and dispose of the consumable 21. The user may subsequently re-use the apparatus 1 with another of the consumables 21. However, in other respective embodiments, the consumable may be non-consumable, and the apparatus and the consumable may be disposed of together once the volatilizable component(s) of the aerosol-generating material has/have been spent.

In some embodiments, the consumable 21 is sold, supplied or otherwise provided separately from the apparatus 1 with which the consumable 21 is usable. However, in some embodiments, the apparatus 1 and one or more of the consumable 21 may be provided together as a system, such as a kit or an assembly, possibly with additional components, such as cleaning utensils.

In order to address various issues and advance the art, the entirety of this disclosure shows by way of illustration and example various embodiments in which that which is claimed may be practiced and which provide for superior heating elements for use with apparatus for heating aerosol-generating material, methods of forming a heating element for use with apparatus for heating aerosol-generating material to volatilize at least one component of the aerosol-generating material, and systems comprising apparatus for heating aerosol-generating material to volatilize at least one component of the aerosol-generating material and a heating element heatable by such apparatus. The advantages and features of the disclosure are of a representative sample of embodiments only, and are not exhaustive and/or exclusive. They are presented only to assist in understanding and teach the claimed and otherwise disclosed features. It is to be understood that advantages, embodiments, examples, functions, features, structures and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist in essence of, various combinations of the disclosed elements, components, features, parts, steps, means, etc. The disclosure may include other inventions not presently claimed, but which may be claimed in future.

1. An assembly for an aerosol provision device for heating aerosol-generating material to volatilize at least one component of the aerosol-generating material, the assembly comprising:
a heating zone for receiving aerosol-generating material to be heated;
a structure; and
at least one continuous electrically conductive path supported by the structure and configured to perform at least one of a first function of detecting a temperature of the heating zone based on an electrical resistance of the at least one continuous electrically conductive path, or a second function of heating the heating zone by resistance heating;
wherein the at least one continuous electrically conductive path extends along at least two distinct portions of the structure;
wherein the at least one continuous electrically conductive path comprises a multiplicity of turns within each of the at least two distinct portions of the structure; and
wherein the at least two distinct portions of the structure are offset from each other by a gap which is substantially free of the at least one continuous electrically conductive path.

2. The assembly according to claim 1, wherein adjacent edges of the at least one continuous electrically conductive path are closer to each other within each of the at least two distinct portions of the structure compared to adjacent edges of the at least one continuous electrically conductive path between the at least two distinct portions of the structure.

3. The assembly according to claim 1, wherein the at least one continuous electrically conductive path comprises a multiplicity of straights within each of the at least two distinct portions of the structure, wherein each straight of the multiplicity of straights is interconnected by two turns of the multiplicity of turns.

4. The assembly according to claim 3, wherein adjacent straights of the multiplicity of straights are spaced apart from each other by a spacing that is smaller in size than the gap.

5. The assembly according to claim 3, wherein a size of the gap is smaller than double a width of each straight of the multiplicity of straights.

6. The assembly according to claim 3, wherein any one straight of the multiplicity of straights extends only part way around the heating zone.

7. The assembly according to claim 1, wherein the gap extends to at least one turn of the multiplicity of turns within each of the at least two distinct portions of the structure.

8. The assembly according to claim 1, wherein the at least two distinct portions of the structure are arranged with respect to each other in a longitudinal direction of the heating zone.

9. The assembly according to claim 1, wherein a first width of the at least one continuous electrically conductive path within at least one turn of the multiplicity of turns is greater than a second width of the at least one continuous electrically conductive path outside of the at least one turn of the multiplicity of turns.

10. The assembly according to claim 1, wherein the at least one continuous electrically conductive path comprises a stress-relief feature comprising:
a first turn in a first direction followed by a second turn in a second direction;
wherein a length of the at least one continuous electrically conductive path between the first turn and the second turn is less than a length of one of the first turn or the second turn.

11. The assembly according to claim 1, wherein the at least one continuous electrically conductive path comprises a connection portion that extends across the gap to connect the at least two distinct portions of the structure.

12. The assembly according to claim 11, wherein the connection portion comprises one turn of the multiplicity of turns.

13. The assembly according to claim 12, wherein the connection portion comprises an internal facing turn that faces towards a center of the gap.

14. The assembly according to claim 12, wherein the connection portion comprises an external facing turn that faces away from a center of the gap.

15. The assembly according to claim 1, wherein the multiplicity of turns comprises at least one 180 degree turn.

16. The assembly according to claim 1, wherein the multiplicity of turns comprises at least one semi-circle turn.

17. The assembly according to claim 1, wherein the at least one continuous electrically conductive path comprises a first portion and a second portion that extend to and cross different respective sides of one of the at least two distinct portions of the structure.

18. The assembly according to claim 1, wherein a number of turns per unit length of the at least one continuous electrically conductive path within one of the at least two distinct portions of the structure is different in one region of the at least two distinct portions of the structure compared to another region of the at least two distinct portions of the structure.

19. The assembly according to claim 1, wherein the multiplicity of turns within each of the at least one continuous electrically conductive path form respective arrays of rows within the at least two distinct portions of the structure and columns within the at least two distinct portions of the structure.

20. The assembly according to claim 1, wherein the structure is or comprises at least one electrically insulating element and the at least one continuous electrically conductive path is a continuous electrically conductive wire encapsulated by the at least one electrically insulating element.

21. The assembly according to claim 1, further comprising:
a plurality of continuous electrically conductive paths,
wherein each of a first path and a second path of the plurality of continuous electrically conductive paths extends along at least two distinct portions of the structure in a respective first region and a second region; and
wherein the first region and the second region are offset from each other by a gap which is free of any one of the plurality of continuous electrically conductive paths.

22. The assembly according to claim 21, wherein the heating zone comprises a first heating zone and a second heating zone, wherein the first path in the first region is to perform at least one of the first function or the second function with respect to the first heating zone, and the second path in the second region is to perform at least one of the first function or the second function with respect to the second heating zone.

23. The assembly according to claim 21, wherein the plurality of continuous electrically conductive paths is supported by a same side of the structure.

24. The assembly according to claim 21, wherein the structure is or comprises at least one electrically insulating element and at least one of the plurality of continuous electrically conductive paths is a continuous electrically conductive wire encapsulated by the at least one electrically insulating element.

25. The assembly according to claim 1, wherein the structure is or comprises an electrically insulating substrate and the at least one continuous electrically conductive path is a continuous electrically conductive track formed on the electrically insulating substrate.

26. The assembly according to claim 1, further comprising:
a plurality of structures provided as a plurality of structure layers; and
a plurality of continuous electrically conductive paths, wherein at least one of the plurality of continuous electrically conductive paths is supported by each one of the plurality of structure layers;
wherein each of the plurality of continuous electrically conductive paths is to perform a different one of the first function or the second function.

27. The assembly according to claim 1, further comprising:
a plurality of structures provided as a plurality of structure layers;
a plurality of continuous electrically conductive paths supported by each one of the plurality of structure layers;
wherein a first path and a second path of the plurality of continuous electrically conductive paths are each supported by a first structure layer, and a third path and a fourth path of the plurality of continuous electrically conductive paths are each supported by a second structure layer;
wherein each of the first path, the second path, the third path, and the fourth path extends along at least two distinct portions of the respective structure in a respective first region, a second region, a third region, and a fourth region; and
wherein each of the first region and the second region on the first structure layer overlaps at least one of the third region and the fourth region on the second structure layer.

28. The assembly according to claim 26, wherein at least one of the plurality of structures is or comprises an electrically insulating substrate and at least one of the plurality of continuous electrically conductive paths is a continuous electrically conductive track formed on the electrically insulating substrate.

29. The assembly according to claim 26, wherein at least one of the plurality of structures is or comprises at least one electrically insulating element and at least one of the plurality of continuous electrically conductive paths is a continuous electrically conductive wire encapsulated by the at least one electrically insulating element.

30. An aerosol provision device for heating aerosol-generating material to volatilize at least one component of the aerosol-generating material, the aerosol provision device comprising:
the assembly according to claim 1;
a controller for controlling a supply of power from a power source to the at least one continuous electrically conductive path of the assembly; and
a detector for detecting an electrical resistance of the at least one continuous electrically conductive path.

31. An aerosol provision system comprising:
the aerosol provision device according to claim 30; and
a consumable comprising aerosol-generating material insertable into the heating zone of the assembly of the aerosol provision device.
